(19) United States
(12) Patent Application Publication
(10) Pub. No.: US 2003/0225839 A1
(43) Pub. Date: Dec. 4, 2003

(54) Knowledge router

(76) Inventors: Dragan Kopunovic, Toronto (CA); Mark Achber, Thornhill (CA); Vojislav Marjanovic, Mississauga (CA)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/162,792

(22) Filed: Jun. 4, 2002

(51) Int. Cl. G06F 15/16

(52) U.S. Cl. 709/206

(57) ABSTRACT

A role-aware, extended-relationship, distributed workflow system includes a knowledge router and a plurality of end devices. The knowledge router maintains a model of information elements employed by participants in a workflow. The end devices are associated with one or more of the participants, and execute portions of the workflow, generating output information elements. The knowledge router receives information elements from the participants and routes these information elements to other participants based on the model.

### FIELD OF INVENTION

The invention relates generally to the software arts, and more specifically to a collaborative computing system and related methods therefore, including a knowledge router.

### BACKGROUND OF INVENTION

Information management has conventionally followed an enterprise-centric model where information has been traditionally viewed as being “owned” by the enterprise. In addition, the conventional paradigm typically views information exclusively in the context of its medium, in which information is always part of something such as a database, spreadsheet, e-mail, etc. Consequently, information is aggregated, managed and protected based on the protection, management and constraints offered by the medium itself.

These conventional approaches are limiting in various ways, particularly when it desired to implement distributed workflows that are processed by multiple persons, parties or automated agents in different contexts. The invention seeks to improve upon the traditional paradigms of information management to provide a multi-point to multi-point collaborative computing system as discussed in greater detail below.

### SUMMARY OF INVENTION

One aspect of the invention relates to a knowledge network which includes a knowledge router and a plurality of end devices. The knowledge router maintains a model of information elements employed by participants in a workflow. The end devices are associated with one or more of the participants, and execute portions of the workflow, generating output information elements. The knowledge router receives information elements from the participants and routes these information elements to other participants based on the model.

More particularly, according to this aspect of the invention, the knowledge router accesses a persistency which stores a model of the workflow. The workflow model preferably includes a plurality of role definitions, a plurality of tasks definitions wherein each task is associated with one or more information elements, mappings between one or more of the tasks and one or more of the roles, wherein at least one information element is directly or indirectly associated with first and second roles thereby defining a shared careabout. Each end device is employed by a participant instantiating one or more of the roles. Each end device accesses a persistency which stores the task definitions associated with the roles the participant instantiates. When one of the end devices associated with a first participant executes a task, it may generate a shared careabout and transmits it to the knowledge router. The knowledge router forwards the shared careabout to the participant associated with the second role.

The workflow model is preferably embodied by information elements which represent various parts of the workflow, such as participants, roles and tasks, as well as the information acted upon by the tasks. The knowledge router preferably includes a topology which defines the logical dependencies between these information elements.

In the topology, at least two information elements respectively provide context_for a third information element. Also, some of the information elements in the topology represent end entities.

The knowledge router receives an input information element from one of the end entities and context information for identifying a direct or indirect input context of the input information element in the topology. The router determines at least one output context for the input information element, resolve one or more end entities logically associated with the at least one output context; and forwards the input information element thereto.

Another aspect of the invention relates to a data structure for defining an information container. The structure includes the following elements or groups of elements: content, and properties of the container. The properties include the following elements: an identifier; at least one context identifier, for logically linking the container to another container; and a type, for identifying the utility of the content. The properties also preferably include one or more of the following elements: a version identifier, for specifying a version of a container definition that the instant container can be compared against; intellectual property rights; and security information. In the preferred embodiment, the foregoing information elements are provided by said containers.

Another aspect of the invention relates to device for use in a knowledge network. The device includes a persistency for storing containers, as described above. The device also includes a messaging service for sending and receiving containers over a network; one or more interpreters having pre-defined methods operating on the content based on its type; and an event manager for actuating one or more of said interpreters based on pre-defined events. The pre-defined event comprises one of: a time or date based event; receipt of a pre-determined container; a change in the state of a container in the persistency; and user-initiated action.

The end device preferably also includes an interaction agent for accepting input from and displaying out to a user or particpant. The interaction agent preferably provides the user with a view of the organization and content of the persistency.

One of the container types preferably designates a workflow task, and a task interpreter is provided for executing workflow tasks. The device can be readily adapted for execution of other content by providing appropriate type definitions and interpreters which include methods for operating on or executing the content. In this sense, the invention provides a commoditized information management system.

### BRIEF DESCRIPTION OF THE DRAWINGS

The foregoing and other aspects of the invention will become more apparent from the following description of specific embodiments thereof and the accompanying drawings that illustrate, by way of example only, the principles of the invention. In the drawings:

FIGS. 1A-1C illustrate symbol conventions used in the drawings.

FIG. 2 is a schematic diagram exemplifying how individuals or other entities interact in differing roles with one or more organizations.

FIG. 3A is a process flow diagram illustrating, generally, a process of defining, delivering and executing distributed workflows in accordance with the preferred embodiment.

FIG. 3B is a system block diagram which specifies in greater detail the physical devices employed in the process flow of FIG. 3A, including end devices and knowledge routers.

FIG. 4A is a schematic diagram which conceptually models the commoditization of the shipping industry.

FIG. 4B is a schematic diagram analogously models commoditization of information management in accordance with the preferred embodiment.

FIG. 5 is a schematic diagram of a protocol stack provided by the preferred embodiment for implementing the commoditization model of FIG. 4B.

FIG. 6 is a schematic diagram illustrating the structure of a container, as per a first layer of the protocol stack.

FIG. 7 is a schematic diagram of a hierarchy of containers.

FIG. 8 is a flow chart showing the processing steps that occur in a container validation layer of the protocol stack.

FIGS. 9A-9E are schematic diagrams showing routing functions provided by a network management layer of the protocol stack.

FIGS. 10A-10D are schematic diagrams of various containers interpreted or parsed by a content execution layer of the protocol stack which provides, inter alia, for the execution of distributed workflows.

FIGS. 11A-11H are schematic diagrams of the state of persistency on a variety of end devices and a knowledge router over time. These diagrams collectively illustrate the process of defining, delivering and executing distributed workflows as generally described in FIGS. 3A & 3B using the commoditized information management model of FIGS. 4B-10D.

FIG. 12A is a block diagram of major software components employed by the end devices.

FIG. 12B is a block diagram of major software components employed by the knowledge router.

FIG. 13 is a schematic diagram of a user interface for the end device, according to the preferred embodiment.

FIG. 13A is a schematic diagram of persistence on the end device when a participant explicitly links information elements from his or her personal space to a relationship space.

FIG. 14-17 detail the persistency of a variety of end devices/participants who assume different roles in an exemplified workflow. The persistency of a knowledge router that routes containers to the various participants is also shown.

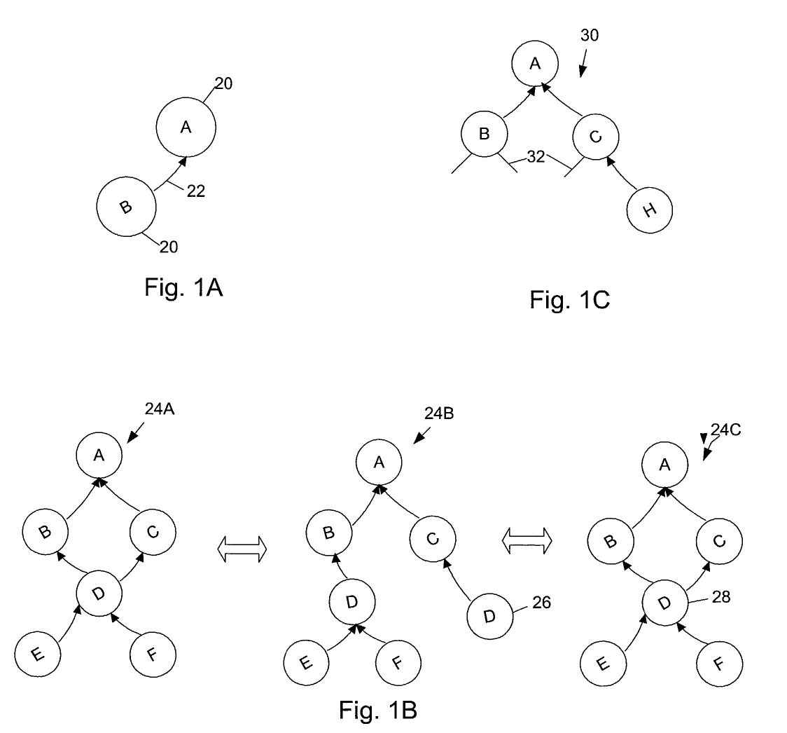

In describing the preferred embodiment use is made of network diagrams. Due to the complexity of representing numerous interconnections and differing types of interconnections between network nodes, a number of conventions used throughout the drawings are described with reference to FIGS. 1A-1C.

FIG. 1A shows a symbol 20 for representing an information element “A”. Symbol 22, an arrow, represents a dependency between information elements (IEs). In the illustrated example, information element A is said to be in the “context of” information element B. Likewise, information element B provides “context for” information element A.

FIG. 1B shows first and second networks 24A and 24B of interconnected interdependent information elements. Note that information element D has a multiple dependency, i.e., it is in the context of both information elements B and C. Since these can sometimes be awkward to represent, stippled symbol 26 may be used to denote that information element D and its progeny already exists in the network, and that a dependency also exists at this point. Thus, the second network 24B is equivalent to the first network 24A.

Sometimes emphasis is placed on the fact that an information element exists in the context of two other information elements, in which case one of the links 28 is shown in stippled lines as shown in a third network diagram 24C. However, network 24C is substantively the same as networks 24A and 24B.

FIG. 1C shows a network 30 having information elements B and C that have non-connected or isolated links 32. The isolated links 32 are intended to represent the fact these information elements provide context for other information elements that are not shown. Accordingly, information element C may provide context for one or more information elements in addition to H.

### DETAILED DESCRIPTION OF PREFERRED EMBODIMENTS

1. Introduction

(a) Role-Aware, Distributed Workflow System

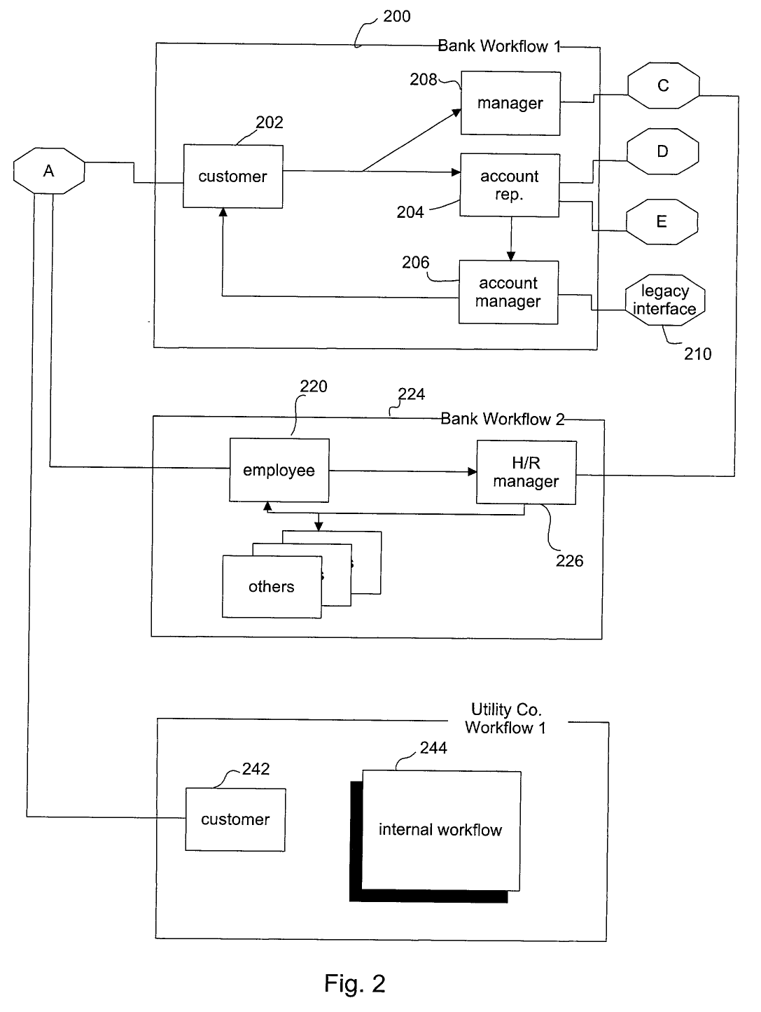

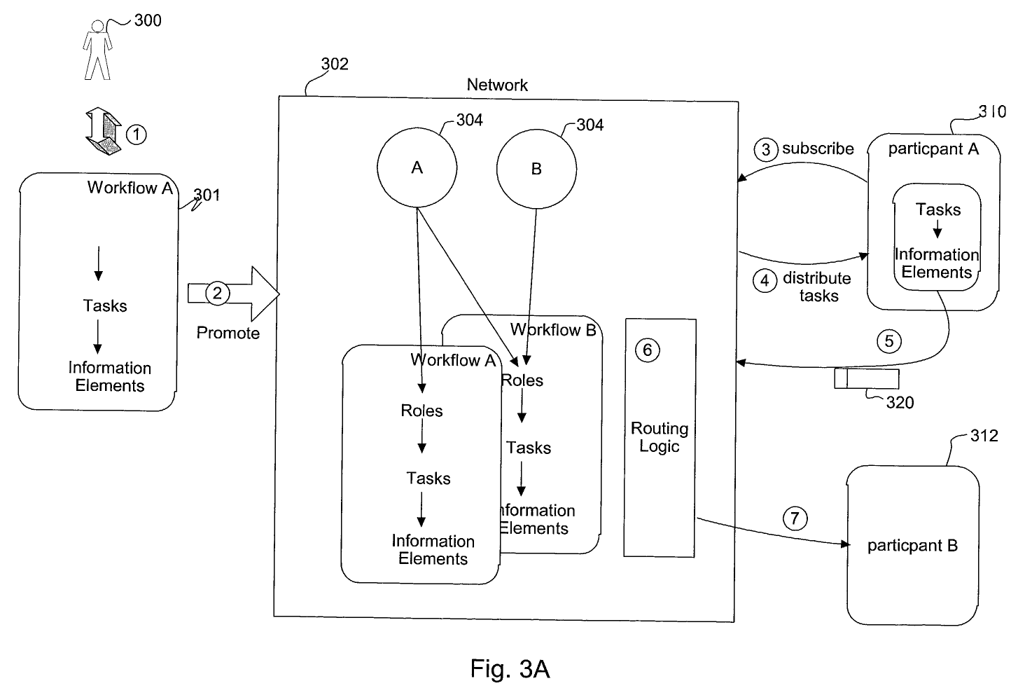

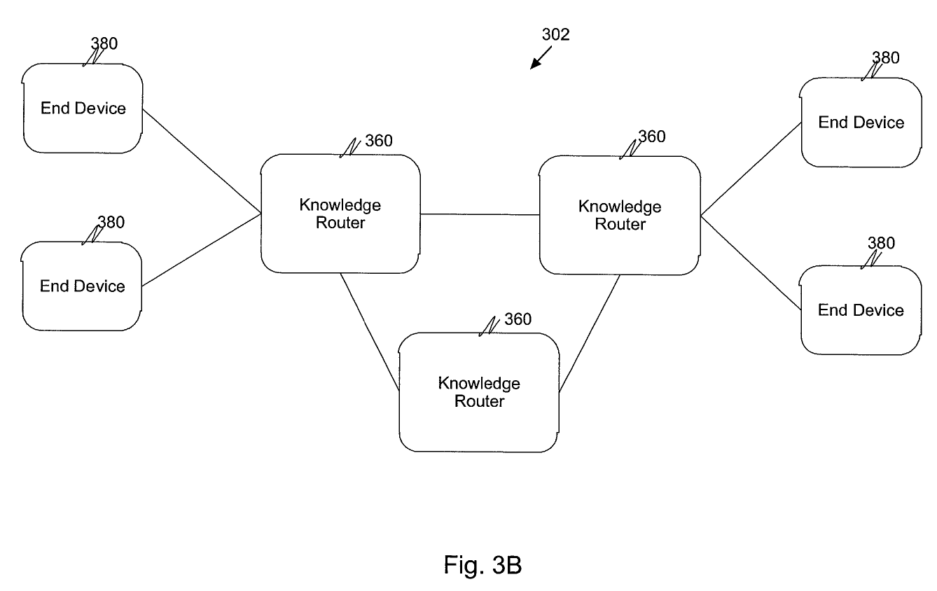

One aspect of the preferred embodiment provides a role-aware, extended relationship, distributed workflow system. An example of this is presented in FIGS. 2, 3A & 3B.

Referring to FIG. 2, consider a prototypical scenario of opening up an account at a bank or other such enterprise. An individual, A, functions as the bank's customer 202, who requests a new account. The bank has decided that the following internal workflow 200 should be followed: An account representative 204 must approve the new account request, following which an account manager 206, e.g., the bank's legacy system 210, will open a new account and send information about it to back to the customer, A. This is predicated on the condition that the customer has already been assigned to an account representative. If not, then a branch manager 208, in this case C, has the responsibility for assigning this specific customer, A, to a specific account representative, who can be individuals D or E. At any time following opening of a new account, the customer 202 or account representative 204 can view its status.

At the same time, individual A may also have another relationship with the bank in the form of one of its employees 220. As such, the bank will likely have another workflow 224 for approving vacations and the like. In this example, employees must make a vacation request to a human resources (HR) manager 226, in this case also individual C, who must approve the request. Once approved, the HR manager informs the employee and others likely to be affected by the vacation.

From the foregoing, it will be appreciated that each of the participants (A, B, C, . . . ) has a role in a business workflow. Each role is associated with a variety of tasks. As part of this workflow, each role “cares about” certain information elements. For example, customers 202, managers 208 and account representatives 206 all care about the “new account request”. This information element will somewhere be defined by a business analyst. The customer role 202 employs this information element as an output of one its tasks, namely the task of requesting a new account. The account representative 204 employs this information element as input to its task of approving new accounts. Similarly, the branch manager 208 needs to know about the new account request to assign a specific account representative to the specific customer, if required. The information element “new account request” is thus characterized as a “careabout” since it is information that a participant requires for the purpose of playing a role in a workflow. More particularly, the “new account request” is also characterized as a “shared careabout” since it is information which more than one participant (or one participant in more than one role) requires for use in one or more workflows.

(b) Subscription and Distributed Execution

Referring additionally to FIG. 3A, the preferred embodiment enables a business analyst 300 to define a workflow 301 in terms of the roles that participants play, the tasks that each role is responsible for, and the information that is shared between roles. (This is denoted as step 1 in FIG. 3A.) As described in greater detail below, the preferred embodiment enables the business analyst to formalize the workflow without having to specifically program it in the conventional sense. Once formalized, the business analyst enables the workflow by placing it on a network 302 (step 2). Users 310, 312 may then subscribe to the pre-defined roles (step 3), thus instantiating one of the roles as symbolically indicated at 304. The users now become participants. As part of, or following subscription, the tasks (task definitions) applicable to each participant's subscribed-to role are delivered to the participant (step 4). As participants execute various tasks they will generate outputs, including shared careabouts 320 which participants in other roles need to execute the tasks associated therewith. The shared careabouts 320 are transmitted to the network 302 which forwards them to other roles (steps 6 and 7), or more specifically participants instantiating those other roles that need the shared careabouts in order to accomplish their tasks in the overall business application. These tasks in turn will generate additional shared careabouts that will be forwarded to other participants in other roles, and so on.

Referring additionally to FIG. 3B, the network comprises one or more knowledge routers 360 which maintain a model of the roles and relationships of various participants, as well as the information that each needs to fulfill its tasks. The participants employ end devices 380 to execute tasks and communicate with the knowledge routers 360. As described in greater detail below, this model is embedded in the workflow(s) 301 provided by the business analysts 300. The knowledge router 360 manages asynchronous notification of changes in shared careabouts 320 to and from the various participants. A shared careabout can be defined with respect to any type of information element including a data field such as textual information, state information such as the state of a virtual button or a step in a workflow. Participants are notified about asynchronous changes in shared careabouts, such a change to a text field or initiation of a step in workflow.

(c) Extended Relationships

So far, workflows have been described with respect to one organization. In reality, users have relationships with many entities, in differing roles. For example, as shown in FIG. 2, individual A can also be a customer 242 of a utility company, which will have its own associated workflows 244. Another aspect of the preferred embodiment allows for the management of extended relationships, which has its own set of problems.

In particular, there can often exist a great deal of friction in transacting with multiple entities. For example, consider what typically happens when someone moves. Many enterprises interact with individuals based, in some part, on one's postal address. Some will send invoices, bills, or accounts; others send information that one has subscribed to such as magazines and newsletters. Some enterprises may modify their interaction with the individual based on his or her address. For example, homeowner's insurance may change if one's principle dwelling changes, while an automobile policy may change if one has to drive further to work or has moved from a high-risk neighbourhood to a low-risk one. Managing this seemingly simple task suddenly becomes quite complex and troublesome, because of the necessity of having to notify a great many interested entities of a change of address—once one has vetted their need to know about that change against one's interest (or lack thereof) in informing these parties.

This scenario is conventionally handled through a series of independent electronic interactions with different entities (not to mention written or verbal correspondence with those organizations that do not have electronic systems for client interaction). These electronic interactions are handled in different ways, because each electronic service, whether a remote connection, website, email, or kiosk is programmed in a different way. It can be a nuisance to deal with each of these systems in disparate ways. For example, each web site will require the user to enter a password but because the formatting requirements of each site are different the user cannot use a single password to interact with each site. Rather, multiple passwords have to be remembered, which can be quite inconvenient. In addition, the user's new address has to be entered multiple times, which can require the user to remember or re-discover complex navigation paths through the web ste, not to mention the nuisance of having to re-type the same information multiple times.

The very same problems exist in many organizations where islands of automated business applications and databases exist.

The preferred embodiment provides a solution to such inconveniences through the mechanism of a shared careabout. In the foregoing example, postal information can be defined as a shared careabout which transcends multiple relationships, as described in greater detail below. However, one of the reasons why conventional approaches to information management have failed to reduce or eliminate the friction in transacting with multiple entities is that all information has been traditionally viewed as being “owned” by the enterprise. In contrast, the preferred embodiment distributes the ownership of information according to its originating source, and distributes the processing of information to participants such as the individual or customer. Having done so, the responsibility can be placed on the owner of the information to define what will become a shared careabout that others should be notified about whenever a change therein has occurred.

(d) Summary

In short, the preferred embodiment transfers responsibility for execution of business processing from the back office systems of service providers to the personal space of the information owner. By shifting the ownership of the information from the enterprise to the source, and through the creation of trusted, process oriented relationships between individuals and enterprises or other individuals, the preferred embodiment allows the information owner to define the privacy and trust policies they choose to operate within—not the other way round. This results in the creation of a true multi-point to multi-point collaborative computing model rather than the traditional organization-centric model in place today.

2. Architecture of the Preferred Embodiment

(a) Separation of Content and Platform

In order to achieve the above noted objectives, the preferred embodiment commoditizes information management. In contrast, conventional approaches to information management view it exclusively in the context of its medium, in which information is always part of something such as a database, spreadsheet, e-mail, etc. Consequently, information is aggregated, managed and protected based on the protection and management offered by the medium itself. However, this very same aggregation is cumbersome and leads to the friction and inefficiencies described above.

A basic concept provided by the preferred embodiment is the separation of platform and content. In the preferred embodiment, platform (or, infrastructure) manages and distributes content.

Content is defined as any information in electronic representation. It lives on its own through its entire life cycle, from creation to death. At birth, it is provided with an identity and protections such as security, integrity, privacy, and intellectual property ownership. The platform is responsible for the protection of content (e.g. ownership, privacy, security, and integrity), its validation, and delivery to the user.

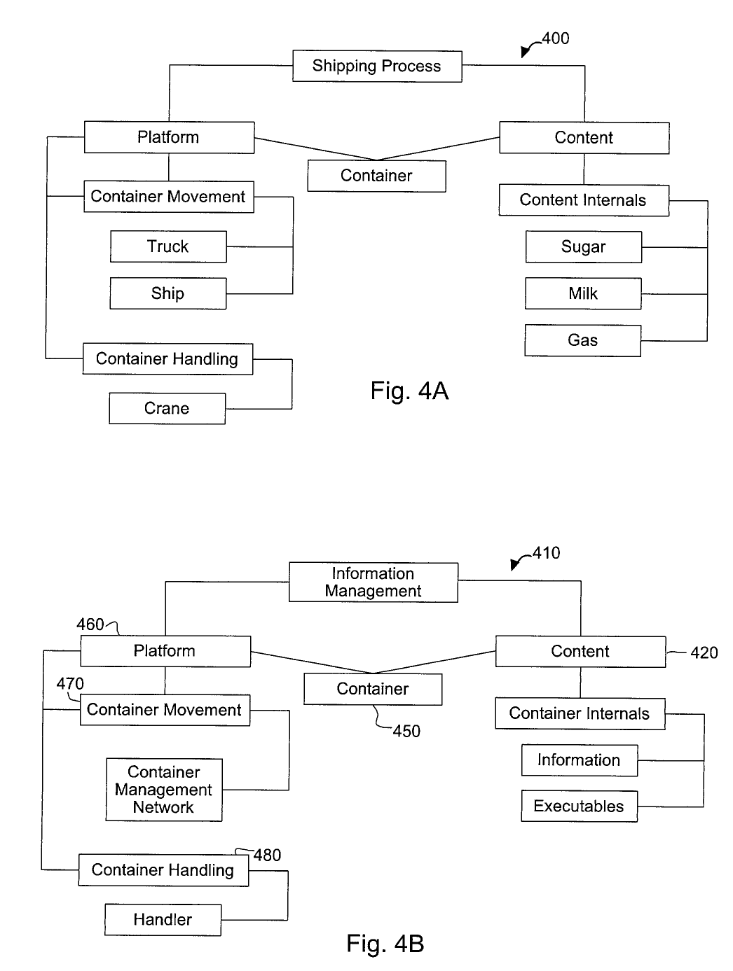

An analogy to this concept is the commoditization of shipping systems, as illustrated in model 400 of FIG. 4A. High efficiencies were achieved when the shipping industry commoditized the handling of goods. Applying this analogy to an information management system 410 as shown in FIG. 4B, content 420 is enclosed in an information container 450 which functions to carry the content 420 securely and reliably. The container 450 encapsulates content and abstracts its key properties.

The platform 460 is the infrastructure which delivers and handles the content. The delivery or container movement aspect 470 is responsible, for example, for routing containers. The container handling aspect 480 is responsible, for example, for managing the creation, distribution, storage, retrieval and enforcement of privacy and intellectual property rights associated with each container.

(b) Protocol Stack

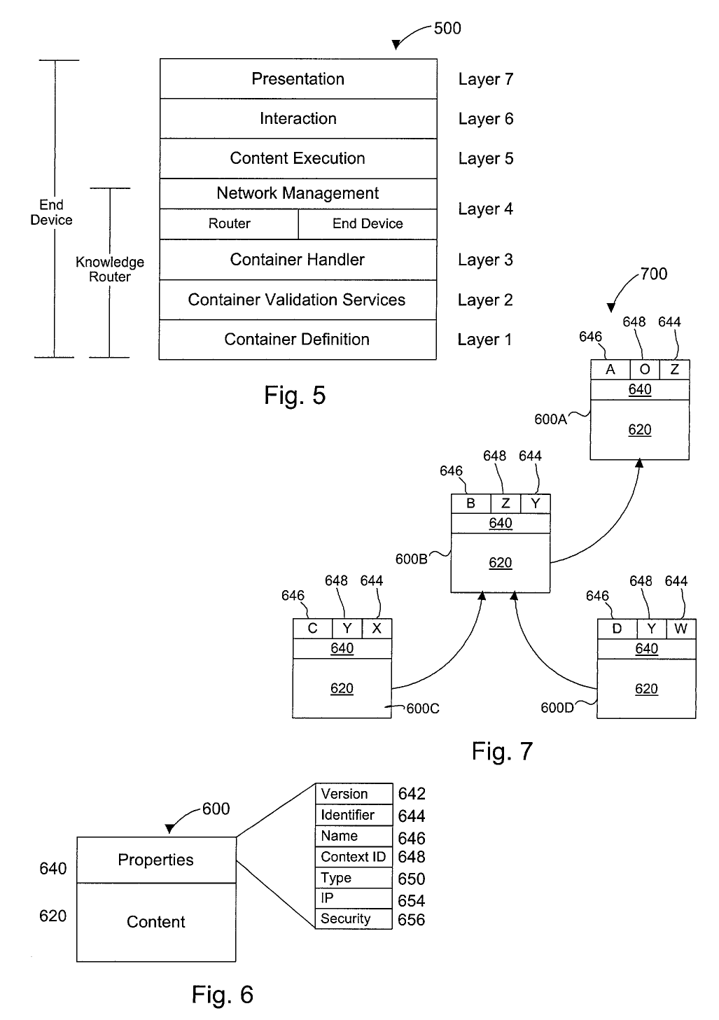

FIG. 5 shows a protocol stack 500 employed in the preferred embodiment which embodies the conceptual model of the information management system 410 shown in FIG. 4B. As well known in the art, in a protocol stack each layer offers services to the layers above, but hides the details of how those services are actually implemented.

Layers 1 to 4 of the protocol stack 500 deal primarily with the delivery or distribution of content. These layers are primarily concerned with the defining a container, validating its structure and content, protecting it, storing it (persisting) in, and retrieving it from persistence. These layers are implemented by the knowledge routers 360 and end devices 380.

Layers 5 to 7 of the protocol stack 500 deal primarily with processing the content—interpreting and “executing” the content, interacting with, and graphically presenting results to, participants. These layers are implemented primarily by the end devices 380.

(c) Container Definition Layer

Layer 1 of the protocol stack 500 provides a definition of container structure, and how the properties of the encapsulated content can be abstracted.

Referring additionally to FIG. 6, a container 600 comprises two basic components: content 620 and properties 640. The content 620 comprises information which is preferably atomic to the application in question. For instance in a library application the content can be a digital movie consisting of megabytes of information; in another application the content can be an atomic data element such as a state in a process flow or one's last name. The content can include other containers, which are preferably recursively stored (i.e., one container in another), although the preferred embodiment is not limited to this.

The properties 640 serve to characterize the content 620. The preferred embodiment includes the following properties:

Version 642. In the preferred embodiment, the network (network management) maintains a definition of container properties. Since these are likely to evolve over time, each definition is labelled with a version control number 642 so that validation checks can be made against the appropriate container definition.

Identifier (ID) 646. This uniquely identifies the container within the network. In the preferred embodiment a hierarchical numbering scheme similar to an Internet Protocol scheme is followed. More particularly, each network element is provided with a unique address, and the ID is a concatenation of the unique address with a unique serial number generated by that element.

Name 646. This provides a user-understandable name 646 for the container.

Context Identifier (CI) 648. This provides a logical reference to another container. Its values are limited to the ID's of other containers. FIG. 7 shows an example of how a hierarchy of containers 700 can be constructed. In this example, container 600A provides context for container 600B, which provides context for containers 600C and 600D. The preferred embodiment employs one CI field per container, but it will be appreciated that more than CI field can be included in the event a container is positioned in the context of two containers.

Content Type 650. In the preferred embodiment, the network (network management) maintains a definition of differing types content. The type is an important parameter because it defines how the content is interpreted by the end devices 380. Types can be elemental or complex. Certain types can also be used for housekeeping purposes, as described in greater detail below.

Elemental types include basic data representations such as integer, text, and boolean types. Human semantic types such as password, zip code, or date are included in this category. This category also includes state designations such as “group”, which specifies that the container/content represents a grouping of other containers, or “role”, which specifies that the content represents a role in a workflow.

Complex types, on the other hand, represent methods that act upon the content. In the preferred embodiment these methods are executed by pre-defined interpreters. Examples of complex types include:

(i) “math”, which specifies a mathematical operation such as “★” that can be executed by a math interpreter. In the process of executing the multiplication method, the interpreter will parse other containers linked to the math container as operands for the mathematical operation.

(i) “task”, which specifies that the container/content marks the start of a task definition provided by linked containers that can be parsed by a task interpreter.

Intellectual Property (IP) 654. This field indicates the intellectual property rights associated with the container. For example, if the content is a movie, the IP field may contain attributes which inform the end device and the network that this movie cannot be copied or transferred. In the preferred embodiment, the IP field is a pointer to a digital license. Digital licences are forwarded to the end devices 380 and comprise a set of rules which determine usage rights, including whether or not the container/content can be employed by the user/end device, e.g., stored or viewed. The license also determines whether the container can be linked with another container, e.g., as a shared careabout.

Security 656. The preferred embodiment employs a public key infrastructure as well known in the art for securing the contents of containers. In the preferred embodiment, the content of particular (or all) containers is encrypted. The security field 656 includes a global public key which, in conjunction with a private key stored on the end devices, can be used to decrypt the content, where required.

(d) Container Validation Service Layer

As shown in FIG. 5, Layer 2 of the protocol stack 500 provides container validation services, to ensure that what a participant or the network receives or sends does in fact comport with the structural definition of a container. This layer is also responsible for validating the right of the participant or network to handle its content, e.g., has the necessary permission to read or modify the content.

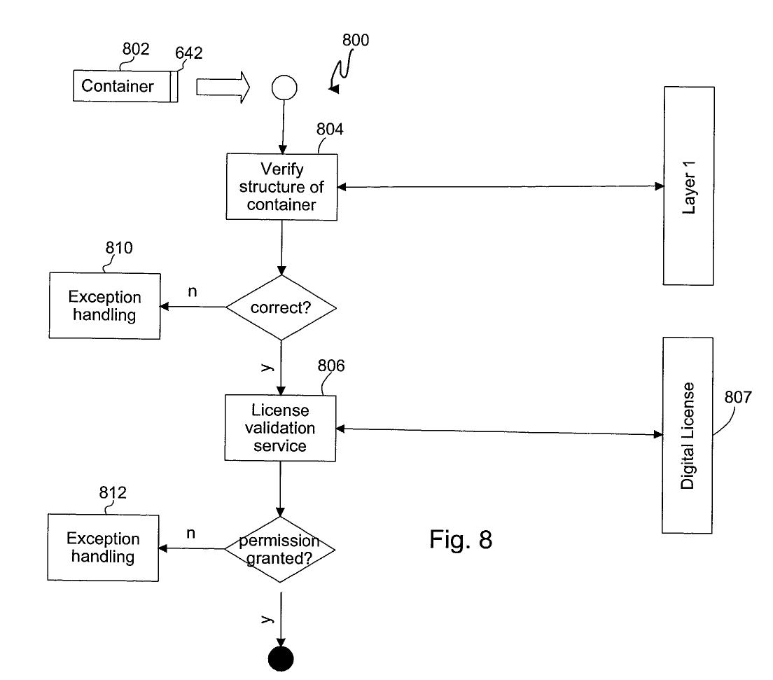

Referring additionally to FIG. 8, a process flow 800 provided by Layer 2 is presented. Upon receipt of an alleged container 802 in a first step 804 the structure of the container 802 is verified. This is accomplished by using the services of the layer 1 which provides the structural definition for a container. Once the structure is verified, a licensing validation service 806 determines whether or not the participant is entitled to the contents of the container 802, based on a digital license 807. In the event the structure is not valid or the participant/network does not have permission to handle the container, suitable exception handling services 810, 812 are invoked. The end result of Layer 2 is confirmation of a valid and useable container.

(e) Container Handling Layer

As shown in FIG. 5, Layer 3 of the protocol stack 500 provides container handling services. These are subdivided into (i) content/container consistency verification, and (ii) persistency and retrieval services.

(i) Content/Container Consistency Verification

As noted above, each container is associated with a property which defines the type of content encapsulated by the container. This sublayer confirms that the content matches the 620 matches the content type 650. For example, the contents of a container of type “integer” are checked to ensure that the content is consistent with the characteristics of an integer.

(ii) Persistency and Retrieval Services

Once the content 620 has been verified against the content type 650, persistency and retrieval services function to store or retrieve containers, as required. Since the containers 620 are always defined in the context of other containers, these services ensure that containers are appropriately inserted or deleted in the local database in such a way that the context links remain consistent and can be easily followed. Smilarly, these services provide higher layers with the ability to retrieve a container, and if required, all or specific lineages of its child containers.

Another important function of the persistency and retrieval service is the ability to create, store, retrieve and otherwise manage careabouts (shared or otherwise) defined on the containers in persistence. One embodiment of the persistency and retrieval services is described in greater detail below.

(f) Container Network Management Layer

Layer 4 of the protocol stack 500 (FIG. 5) provides network management services, the primary function of which is to distribute or route containers based on shared careabouts. Since the knowledge routers 360 and end devices 380 function differently in this process, these services are subdivided into device-specific parts.

(i) Context-Based Routing

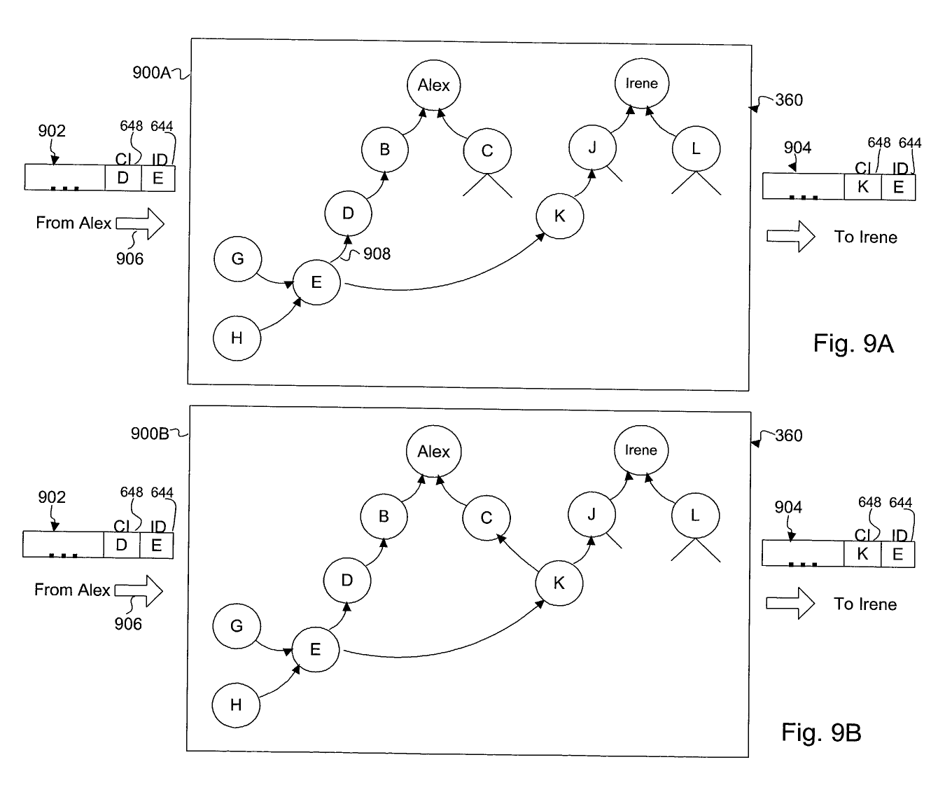

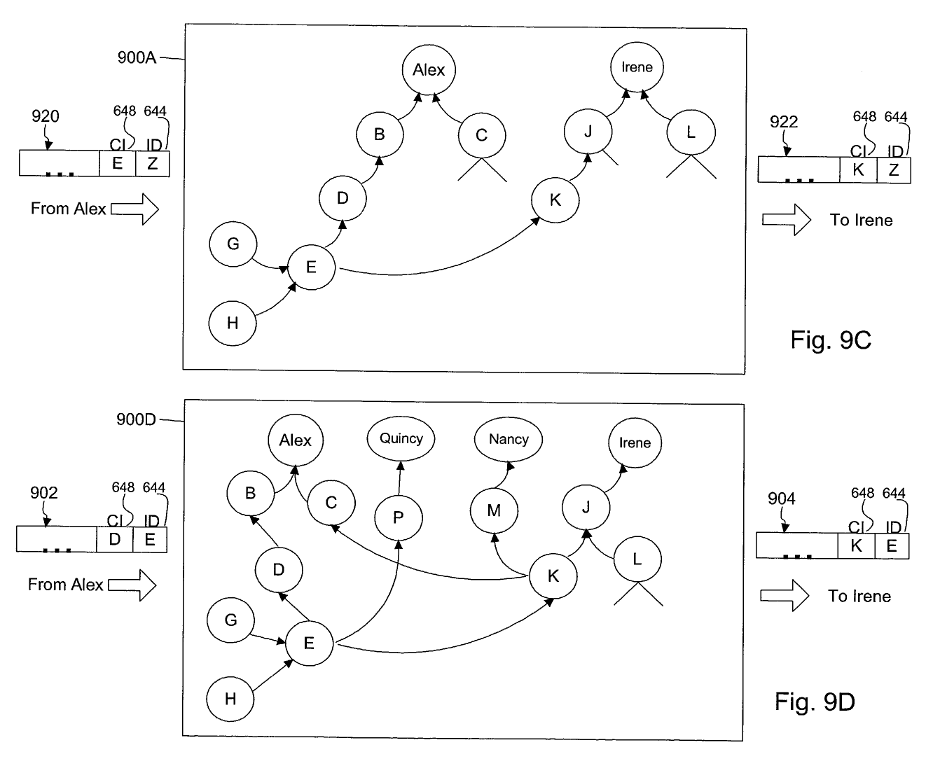

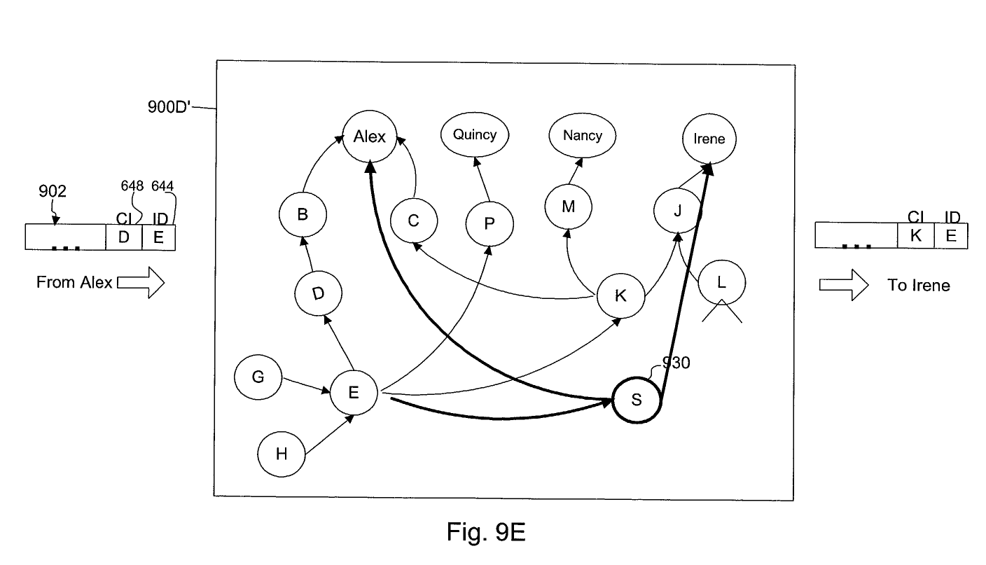

A fundamental function of the knowledge router 360 is to route or distribute containers that are specified to be shared careabouts. FIG. 9A exemplifies just such a situation. The router 360 includes a topology base 900A which specifies a hierarchy of containers and their shared careabouts. As will be seen in this example, containers D and K respectively provide context for container E. In this particular example, containers at the root level of the hierarchy represent participants, in this case Alex and Irene. Viewed from another perspective, container E is a shared careabout for both Alex and Irene.

As shown in FIG. 9A, the knowledge router 360 receives from one of the participants a container 902 with its ID field set to E (the “input container”). In addition, the router also receives context information which specifies a direct or indirect dependency of the input container in the topology. The context information can be one or both of: (i) the context identifier 648, in this example D, which specifies a direct dependency of the input container; and (ii) the identity 906 of the participant that sent the input container 902, which specifies an indirect dependency of the input container. In the preferred embodiment, the knowledge router receives both pieces of information.

This information allows the knowledge router 360 to determine an input context for the input container 902 relative to the topology 900A. In this example, container D (or container Alex) provides the input context for the input container 902. From this, the knowledge router 360 can determine at least one output context for the input container 902, which in this example is container K. This allows the knowledge router to resolve the participants or end entities logically associated with the output context. In this example, the identities of the participants associated with the output context can be resolved by following the topology 900A starting from the output context (container K) to the root level, which yields Irene. The knowledge router then forwards the input container 902, which now becomes an output container 904, to Irene. In the output container 904, however, the context identifier 648 is set to the output context, which in this case is now container K.

In the foregoing example, the context identifier 648 provided sufficient information in and of itself to route the input container 902 (to Irene) since the router will not traverse branch 908 of the topology 900A which encompasses the container pointed to by the input context identifier, thus eliminating the sender (Alex) from consideration. However, it is possible for the sending participant to be associated with the output context as exemplified in topology base 900B of FIG. 9B, where container K is ultimately a shared careabout for both Alex and Irene. In the preferred embodiment, since the knowledge router receives the identity of the sending participant as part of the input context, the router will not ordinarily forward the input container 902 back to the sender, although this can be specifically overridden as described below. Note that in alternative embodiments the knowledge router may implement an exception to this rule and forward the input container back to the sender if the input container is required in the instantiation of another role.

The foregoing examples have demonstrated the process of resolving the identity of participants by traversing the topology to the root containers. In alternative embodiments containers can be defined with a pre-determined content type (another example of a housekeeping type) which specifies that the container represents a participant. Upon traversing the topology, the router stops its search (i.e., stop traversing a branch or path of the topology) when a container of the participant type is encountered.

(ii) Dynamic Context Routing

In the foregoing examples the router was able to ascertain the position of the input container in the topology. In some cases, however, the router can receive a container whose identity and hence position is not present in the topology. Nevertheless, if the context identifier 648 provided by the input container is present in the topology then the input container can be routed using the properties of the container which provides context for the input container. An example of this is shown in FIG. 9C, where the router receives an input container 920 (ID=Z), in the context of container E. The router forwards input container 920 to Irene, based on the properties of container E.

Thus, it will appreciated that routing can be accomplished either on the basis of: (i) matching the identity (i.e., position) of a container in the topology, coupled with direct or indirect context information; or (ii) the context identifier, which provides direct context information, and indirect context information, e.g., the sender. In the preferred embodiment, the default routing behaviour is based on the first rule, but in the event it returns a negative result the router resolves based on the second rule, namely the properties of the container pointed to by the context identifier of the input container.

(iii) Steering Information

There can also be situations where the resolution process yields multiple participants. For example in topology 900D of FIG. 9D two output contexts, K and P, exist for the input container, the resolution of which yield participants Irene, Nancy and Quincy. Absent other information, the knowledge router will forward the input container to all these participants. However, it is possible to incorporate steering information into the topology which will enable the router to choose a specific participant to whom the input container should be forwarded.

In the preferred embodiment steering information is provided through the provision of a “connector” type (which falls under the category of a housekeeping type of content). As shown in FIG. 9E, container S (ref. no. 930) is of type “connector”, and links container E with Alex and Irene. Lpon receiving the input container 902, the knowledge router identifies multiple output contexts, K, P and S. However, the connector container 930 overrides the default behaviour of the router so that it forwards the input container 902 only to participants linked through the connector container 930, which in this case is Irene, and not all possible participants. Note that if the input container had arrived from Irene the router would have forwarded the input container to Alex. It will be appreciated that the steering information could also establish a loop whereby the sender of a container is also a recipient thereof. This is accomplished, for example, by linking the connector container 930 to Alex twice.

(g) Content Interpretation Layer

Layer 5 of the protocol stack 500 “executes” the content encapsulated in containers, based on its content type. Execution occurs primarily in the end devices 380.

Complex container types are preferably defined in anticipation of interpretation/execution. For example, one of the objectives of the preferred embodiment is to be able to execute role aware, distributed workflows, as described above. Therefore, the preferred embodiment employs a “workflow” container type. However, this in itself is insufficient to implement a real workflow. Rather, the workflow container is a cue to an interpreter that a variety of other containers are expected that have a pre-defined relationship the workflow container. In this layer, through the interpreter: (a) the relationships between containers of differing content types are defined and checked for consistency, and (b) content is “executed” in accordance with its type using pre-determined methods or rules.

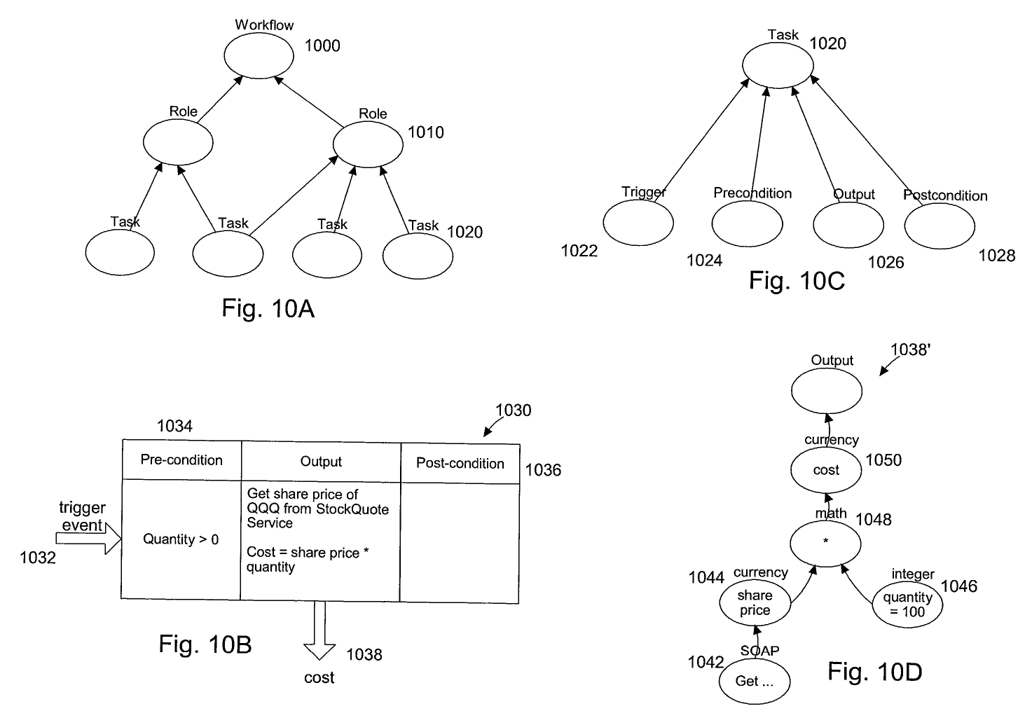

These concepts are presented in greater detail with respect to FIGS. 10A-10D. As shown in FIG. 10A, a workflow 1000 is defined such that it provides context for one or more roles 1010, and for one or more tasks 1020 associated therewith. Thus, an interpreter for the workflow type would run consistency checks to ensure that content/containers of role and task types exist in the expected dependencies.

In the preferred embodiment a container of type workflow functions as a marker, with very little “execution” required in the conventional sense. However, the task type is intended to execute a process 1030 as schematically depicted in FIG. 10B, whereby the related methods are more complex. Under this process, a task is executed when a particular event 1032 occurs. The event can be, but is not limited to, reception of a particular container from the knowledge router 360; a change in the state of a careabout in the local persistency; user-initiated action, such as will occur when a user clicks a mouse button to execute a function; and a time or date event. In the preferred embodiment, before the task can be executed a pre-condition 1034 must be met, and a post-condition 1036 must also be met after the task finishes executing. The output 1038 of the task results from executing particular content.

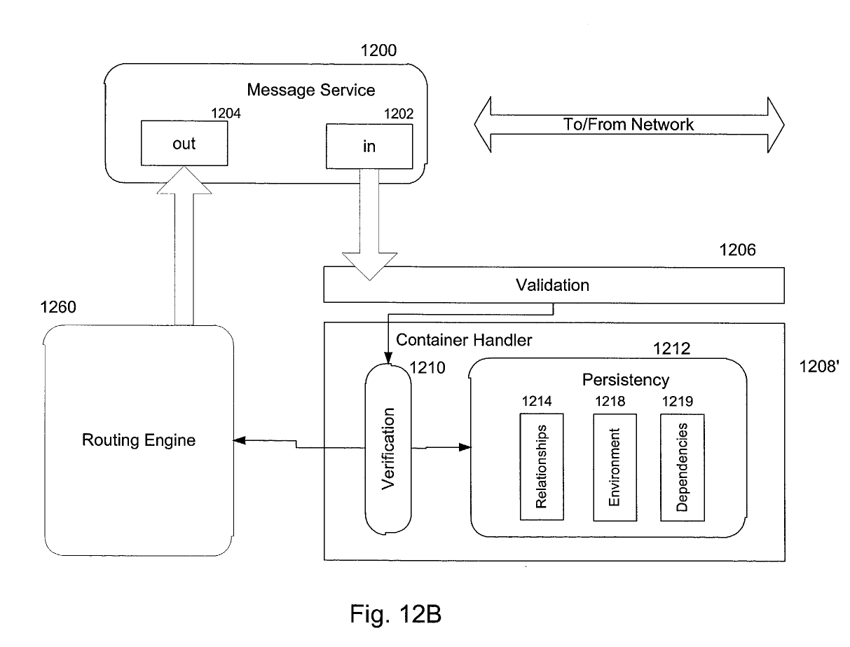

This process 1030 is represented by containers 1022-1028 of corresponding types as shown in FIG. 10C. Thus, as discussed in greater detail below with reference to FIG. 12A, when a container 1020 of type task is received, the corresponding interpreter is called and consistency checks are made to ensure that a minimally required set of these content types are associated with the task container 1020. The preferred minimal set is containers 1022 and 1026 of type trigger and output.

Note, however, that there is not necessarily a 1:1 mapping between content types and interpreters since some interpreters will be able to execute or parse multiple kinds of types.

The interpreter also executes the task defined by the linked containers when the triggering event 1032 occurs (events are handled by an event manager 1220 as shown in FIG. 12A), ensuring that the pre-condition 1034 is met, if any, processing and generating the output 1038, and ensuring that the post-condition 1036 is met, if any. For example, FIG. 10B illustrates the following logic:

(a) a pre-condition that variable “quantity” is greater than 100;

(b) no post-conditions; and

(c) an output, cost, which is equal to a share price, as obtained from a particular data source, multiplied by the quantity.

As discussed in greater detail below, tasks are preferably “coded” by business analysts using a tool that directly translates or compiles a workflow modeling language such as the industry standard Dynamic State Modeling schema into containers. (Viewed from this perspective the containers can be understood to be compiler tokens.) FIG. 10D shows a possible compilation 1038 of the output logic presented in FIG. 10B into containers (those skilled in the art appreciating that many renderings may be possible, depending on the design of the compiler).

The task interpreter parses the containers, calling other interpreters as needed, in order to generate the output. In FIG. 10D, container 1042 represents a request to retrieve data from a data source. In this particular example the container has a content type of SOAP, indicating that a request should be made by a Simple Object Access Protocol service/interpreter to retrieve the stock price of ticker symbol QQQ. In this case, the task interpreter invokes the SOAP interpreter/service which, by virtue of the dependency between the SOAP container 1042 and another container 1044 named “shareprice” of content type currency, inserts the retrieved stock price into container 1044.

Similarly, the contents of container 1046 named “quantity” is 100, representing 100 desired shares. The content type of container 1048 is a mathematical operator, and its content is a multiplication sign. Upon encountering the math operator container, the task interpreter calls a math interpreter which, by virtue of the dependencies between the containers, multiplies the share price by quantity and places the result in a cost container 1050.

(h) Interaction Layer

Layer 6 of the protocol stack 500 is responsible for interacting with participants, including requesting input and displaying information. By implication certain types of containers are not involved in I/O activities, e.g., containers of type “group”, but others may be, such as type “integer”. As the interaction layer is called by the content execution layer, the function of the former is closely related to the function of a specific interpreter invoked in the latter. The function of the interaction layer for basic data input/output in the execution of tasks is describe in greater detail below.

(i) Presentation Layer

Layer 7 of the protocol stack 500 provides one or more styles of presentation or “skins” which can be selected by the participant. Where the participant is a machine such as a legacy system, the presentation layer is instantiated as methods providing the I/O formatting requirements of the machine.

3. Implementation of Architecture

(a) Process Embodiment

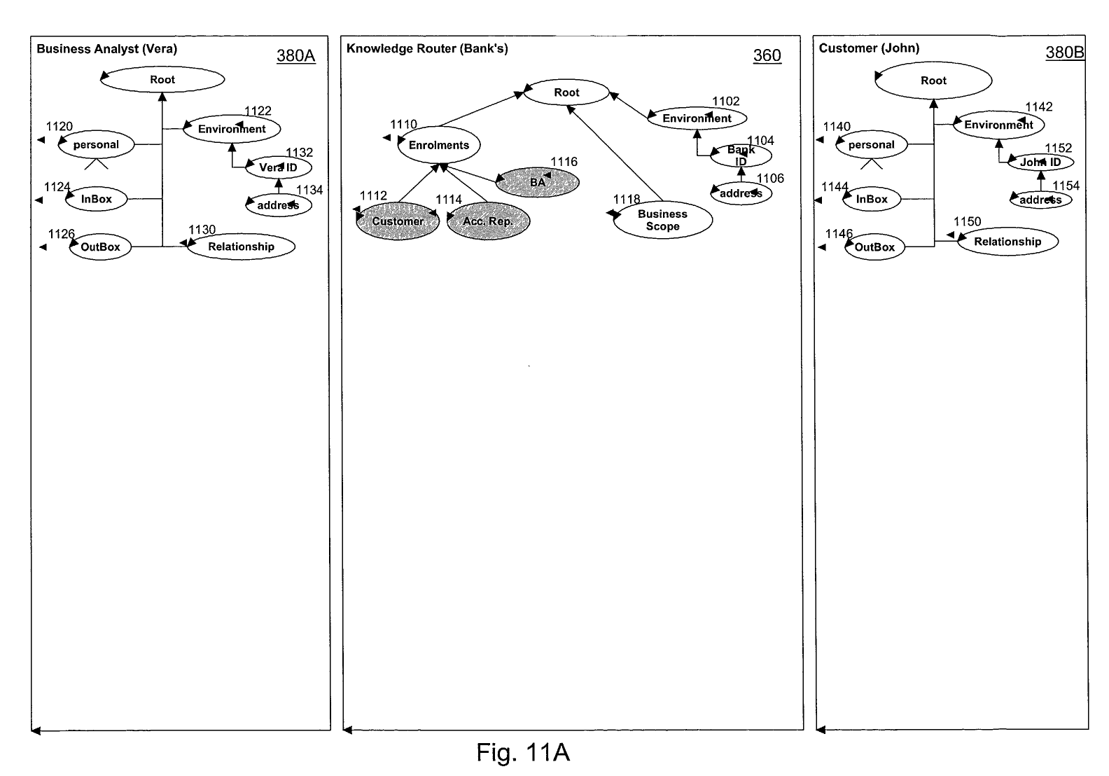

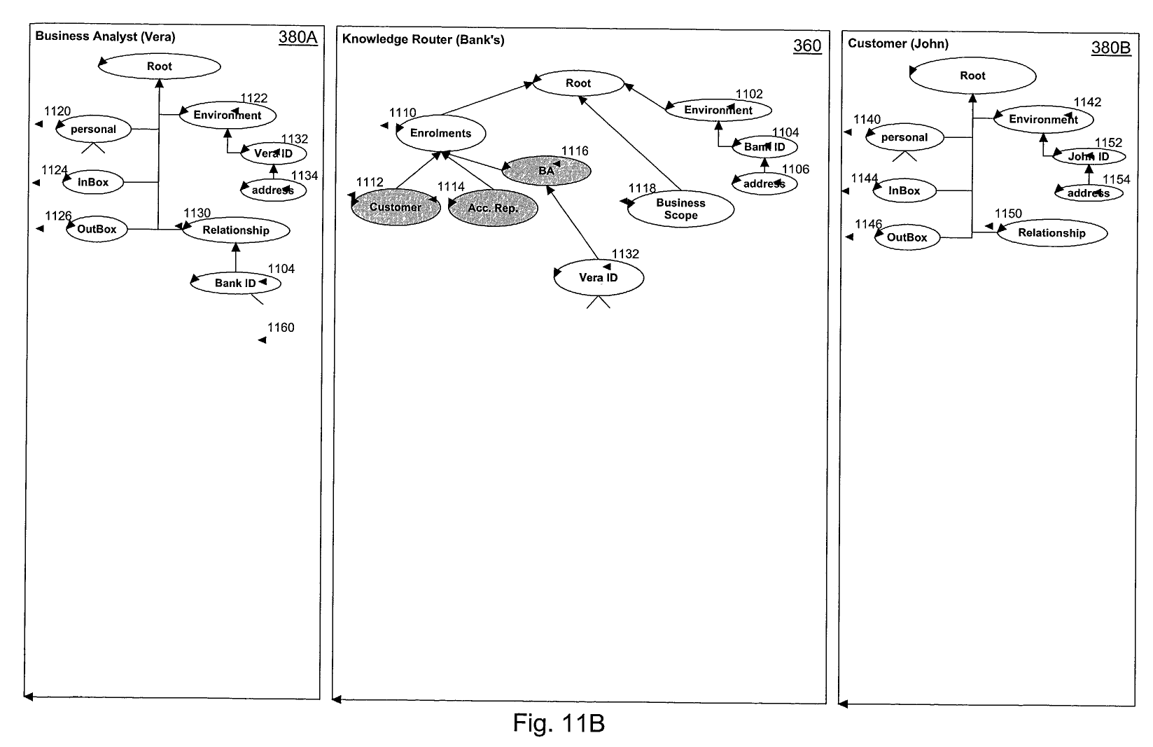

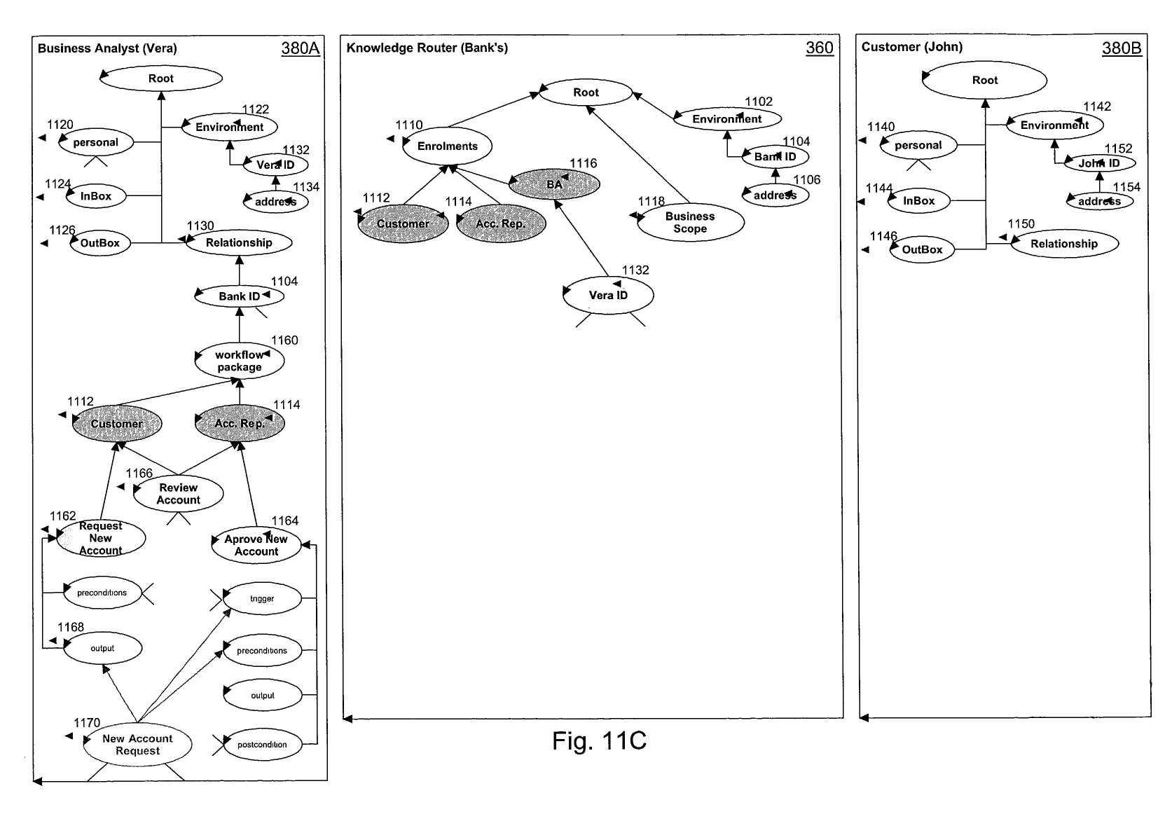

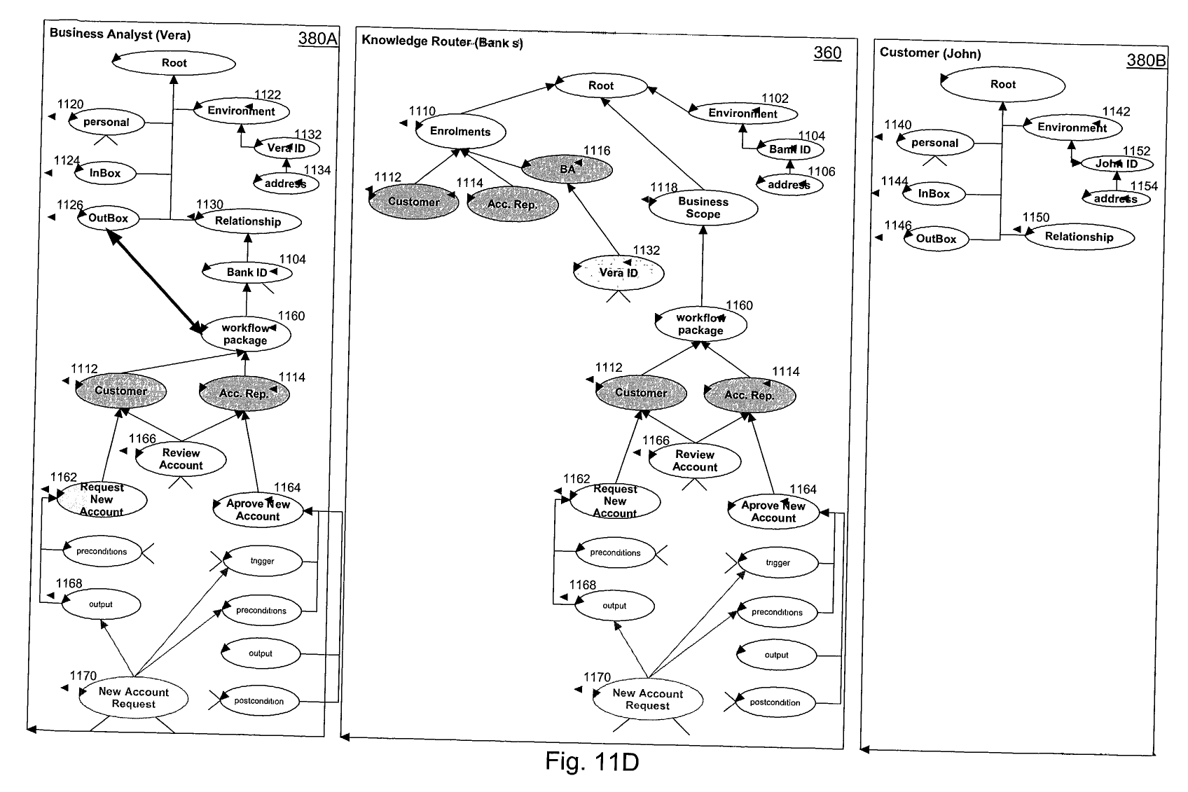

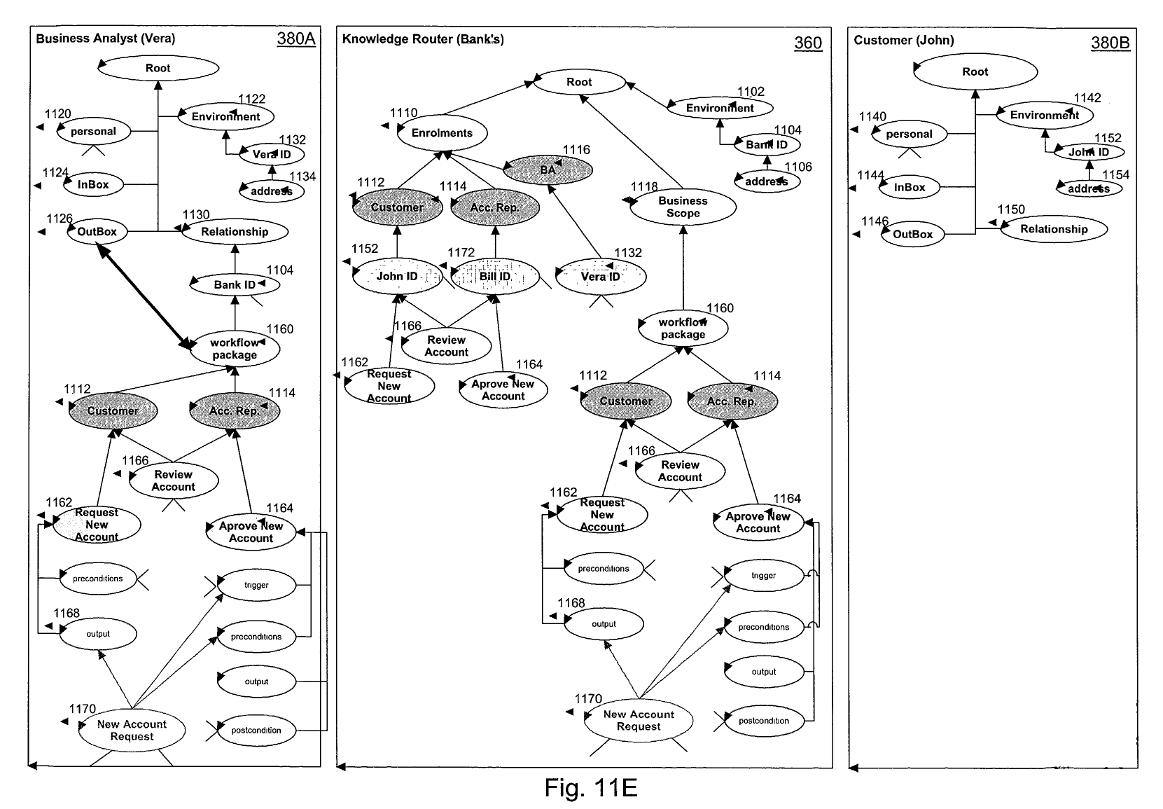

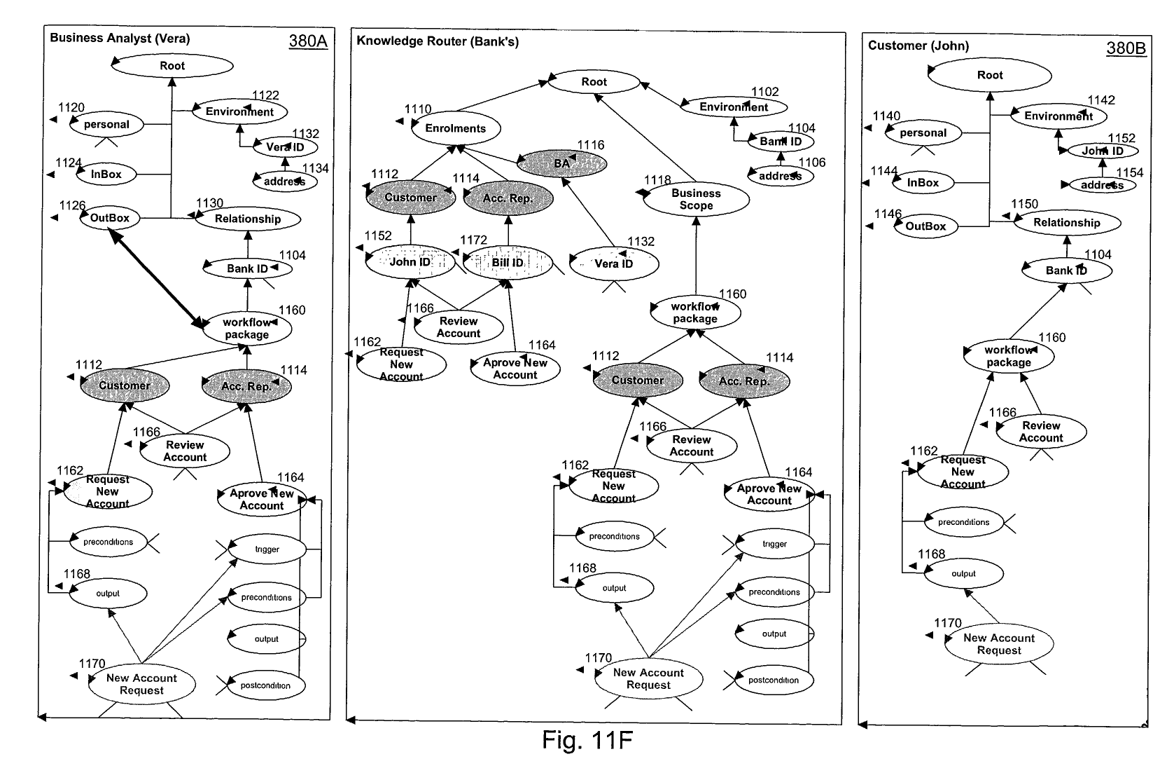

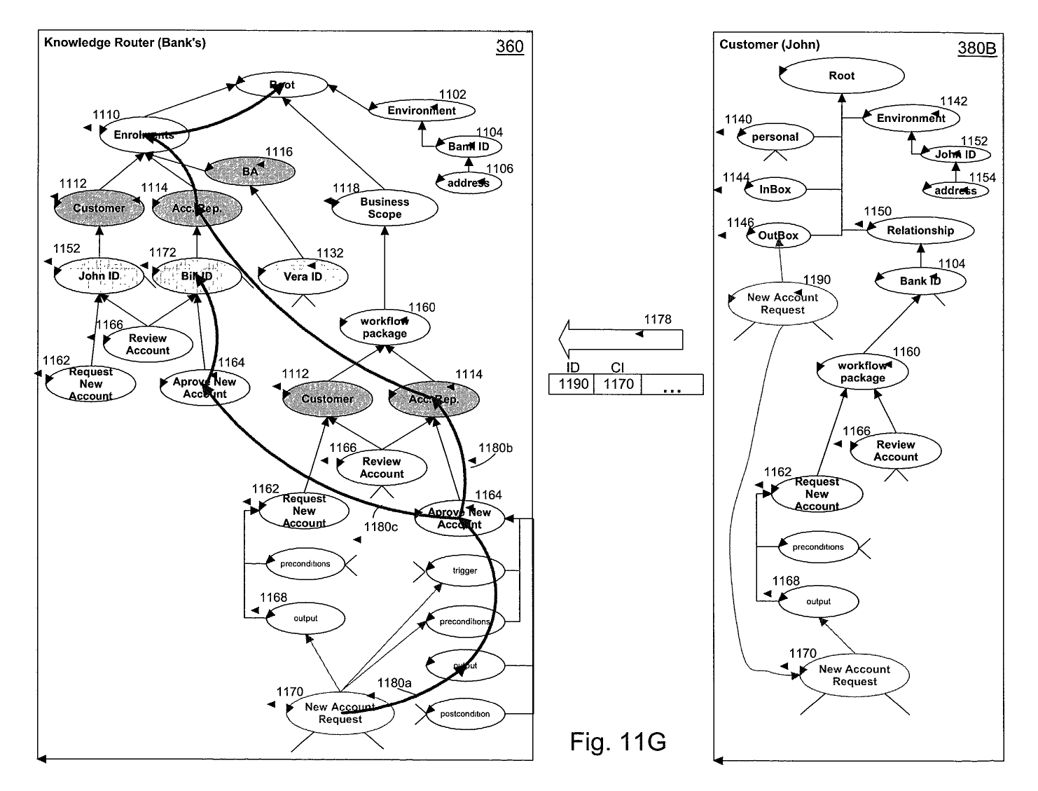

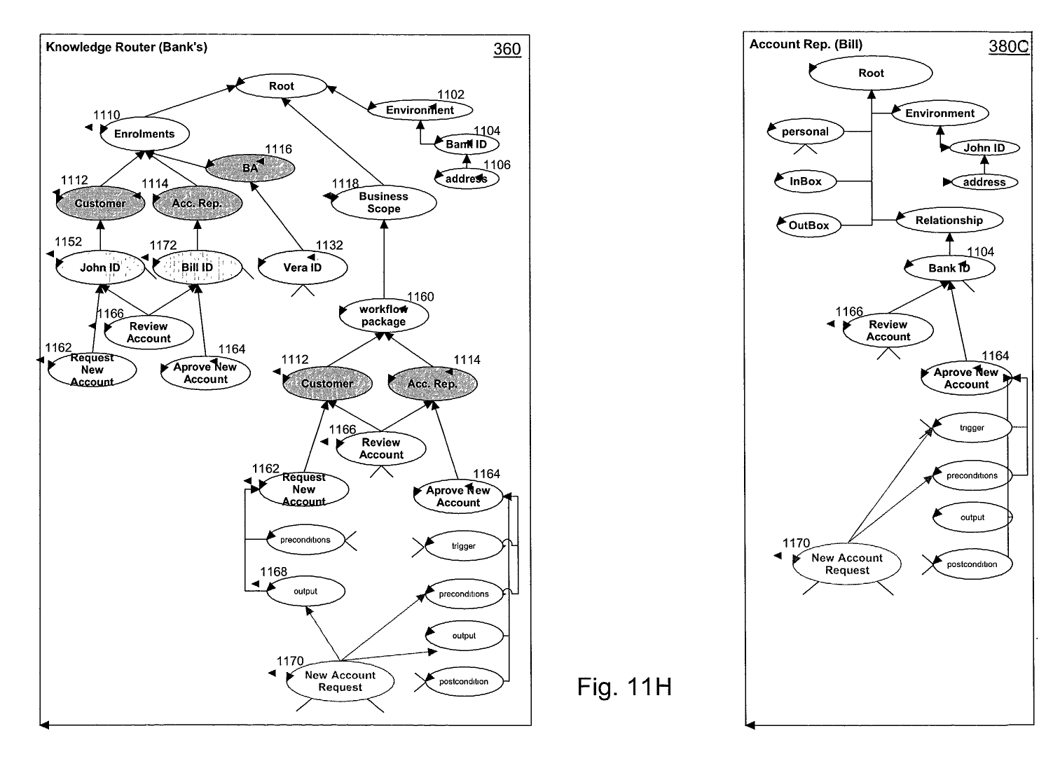

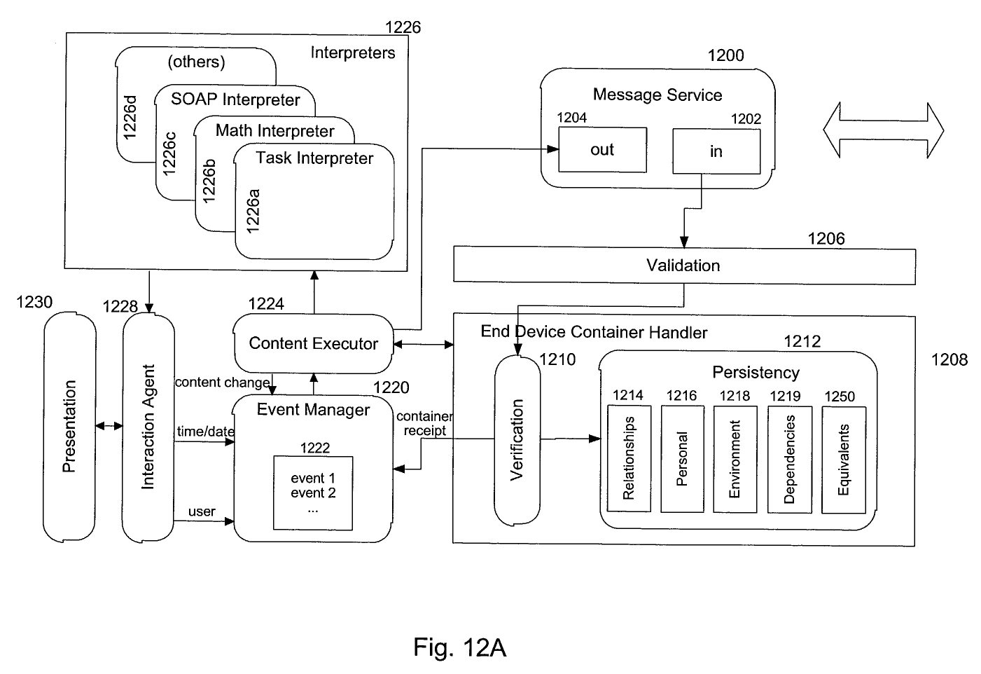

Having described all of the major conceptual building blocks of the preferred embodiment, FIGS. 11A-11H describe the process according to the preferred embodiment of workflow enablement, role subscription, and distributed workflow execution in greater detail using the customer/bank scenario described with reference to FIG. 2.

FIGS. 11A-11H show relevant portions of the persistence on the knowledge router 360 and the end device 380B of a participant, John, who assumes the role of a customer. In addition, these drawings show relevant portions of the persistence on the end device 380A of a business analyst, Vera in this example. Note that FIG. 11A shows the initial conditions of the persistency on each device. Each participant, including Vera the business analyst, includes personal, environment, inbox, outbox and relationship containers 1120-1130 (on device 380A), and 1140-1142 (on device 380B). Each environment container 1122 or 1142 groups together information (containers 1132, 1134 or 1152, 1154) about the logical ID of the device as well as its network address. In these diagrams, only the container names are shown, not the contents. Each personal container 1120 or 1140 groups together information about the participant, such as his or her name, address and other such personal information (the particulars of which are not shown). Each relationship container 1130 or 1150, which initially has no dependencies, is intended to link content pertaining to the participant's relationship with other participants. Each outbox container 1126, 1146, initially having no dependencies, is intended to link shared careabouts that will ultimately be forwarded to other participants. Each inbox container 1124 or 1144, also initially having no dependencies, is intended to store containers received from the knowledge router 360 which will be dispatched for execution based on content type, as discussed above.

The knowledge router 360 includes an environment container 1102 which groups together information about the logical ID 1104 of the router (i.e., representing the bank) as well as its network address 1106. An enrolments container 1110 groups together containers 1112, 1114, and 1116 representing various pre-defined roles, in this limited example customer, account representative and business analyst roles. (Note that, in practice, the business analyst will define and enable the roles, but this step is not shown for simplicity of explanation.) A business scope container 1118, which initially has no dependencies, is intended to group together one or more workflows that the router is responsible for routing.

In a first step shown in FIG. 11B, Vera subscribes to the knowledge router in the role of a business analyst. This is accomplished through the services of pre-defined logic or a pre-defined task on her end-device which sends the Vera ID container 1132 to the knowledge router. This container has a content type of “participant” and contents which logically represent or identify Vera. Vera's network address container 1134 is also sent. The knowledge router, preferably using predefined logic, places these containers in the context of the business analyst role/container 1116. In addition, the knowledge router forwards its identity and network address stored in containers 1104 and 1106 to Vera's end device 380A which persists same in the context of relationships container 1130.

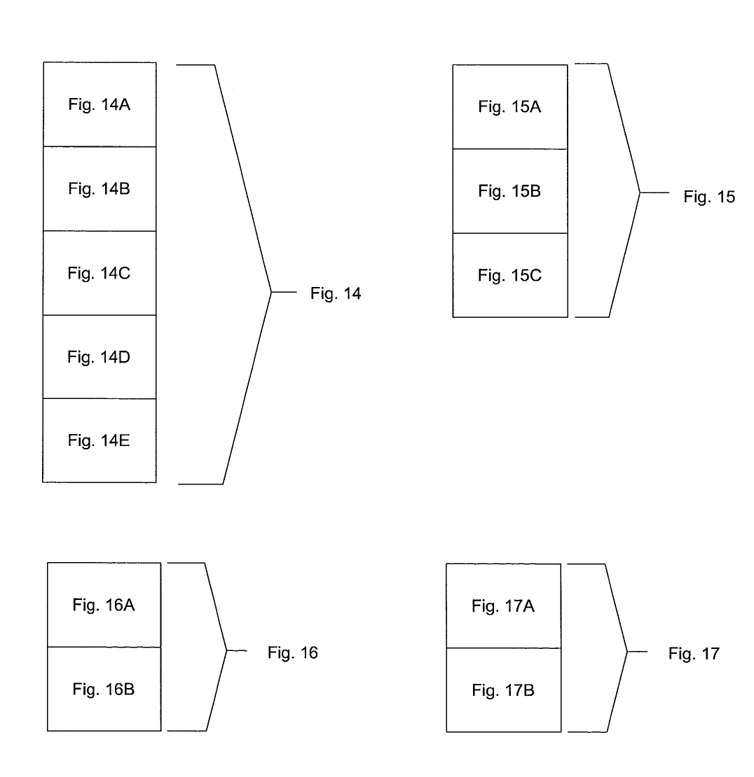

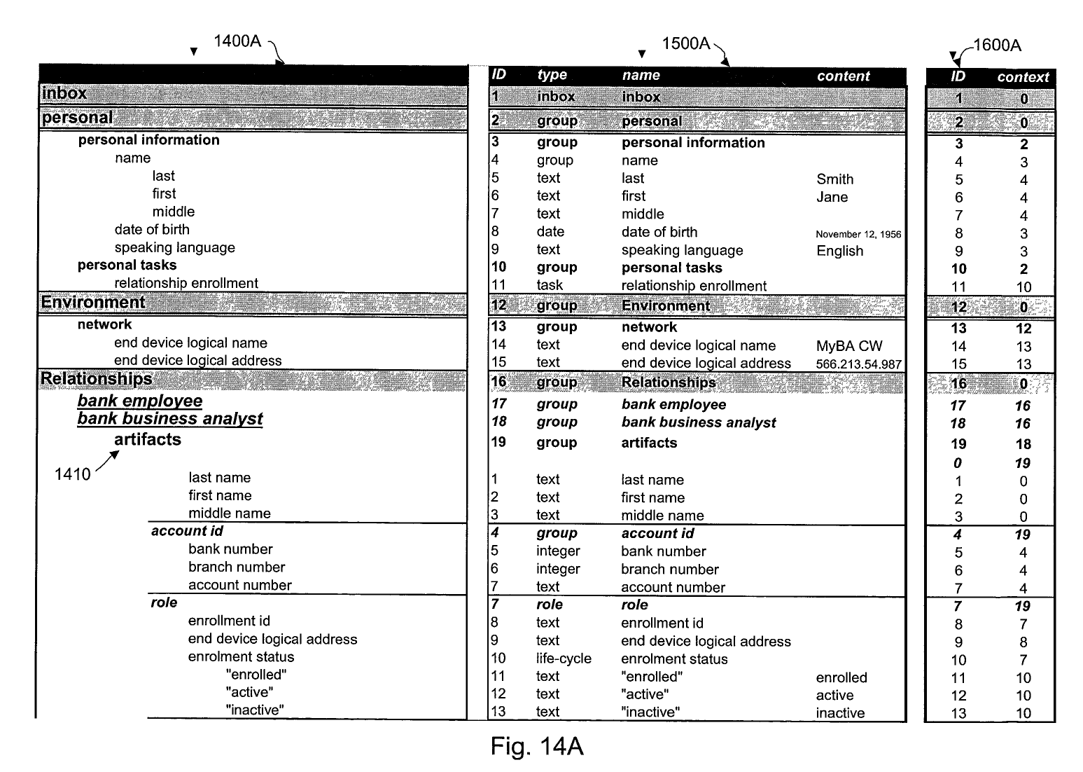

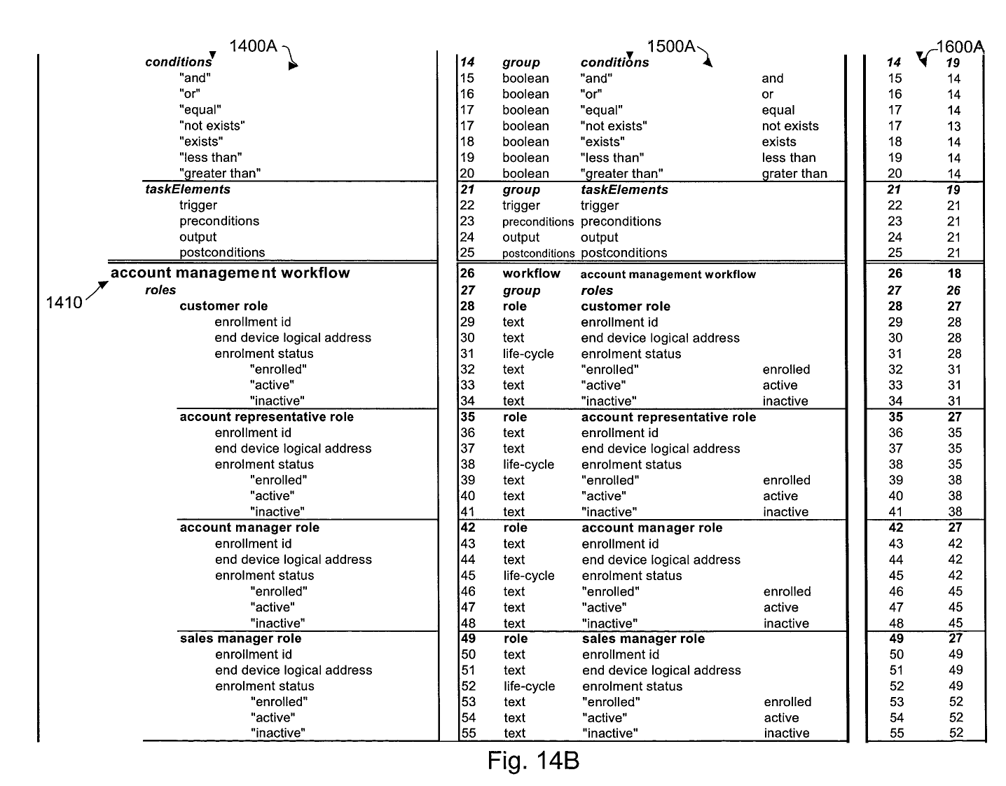

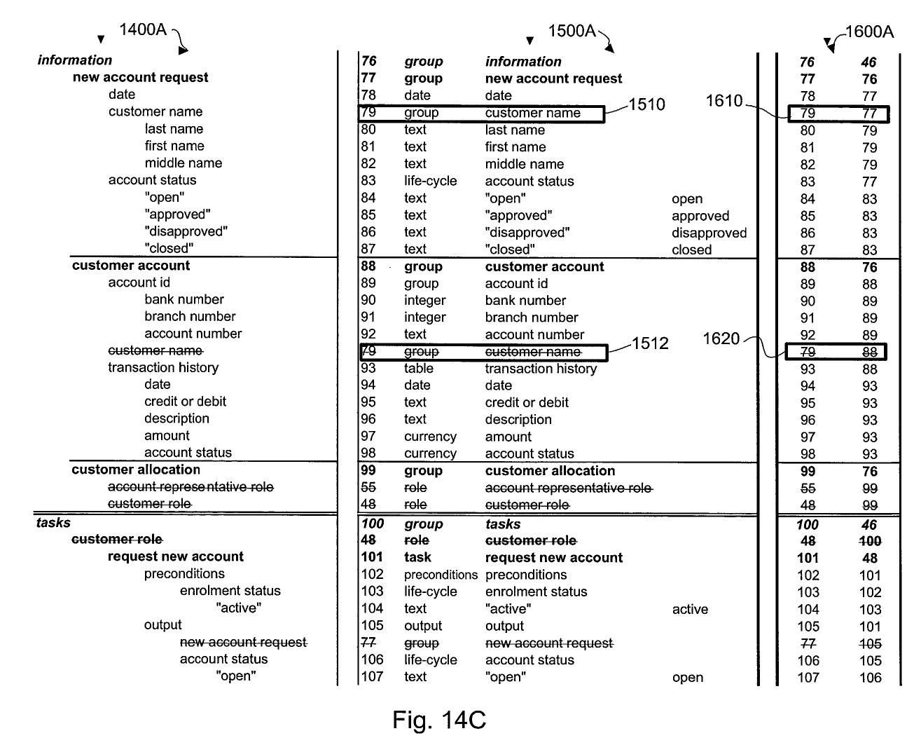

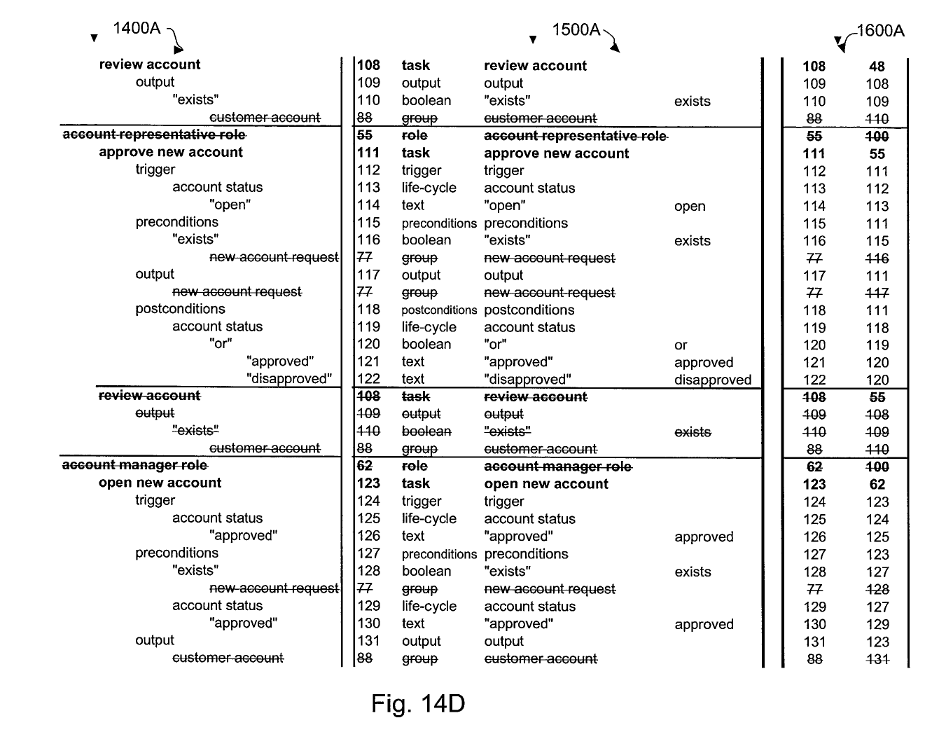

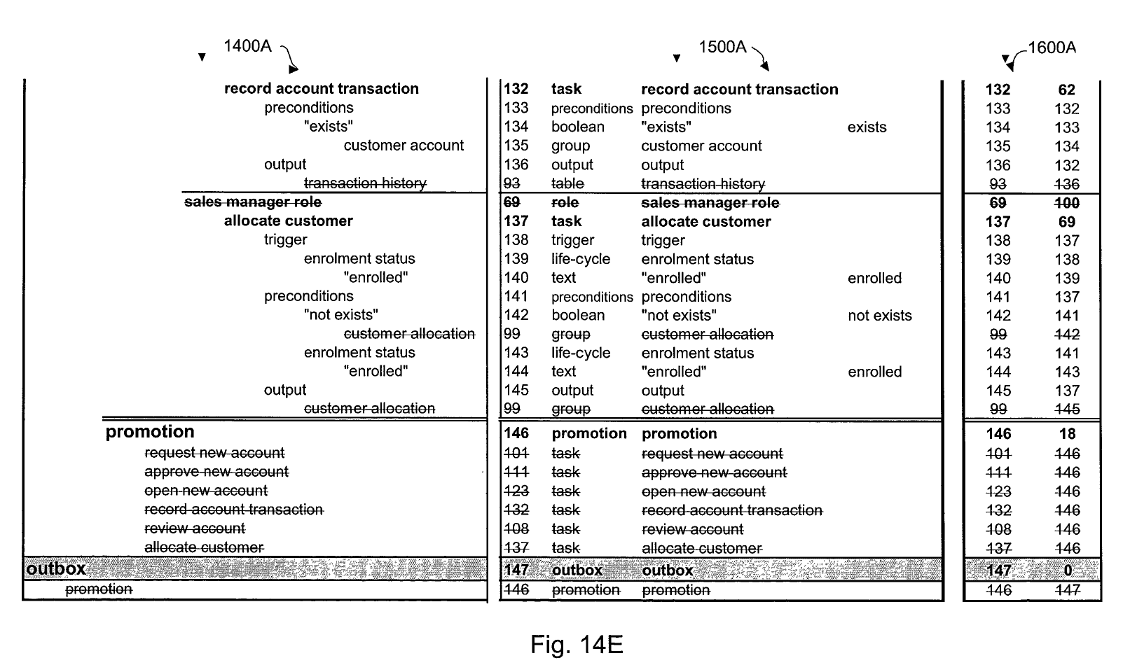

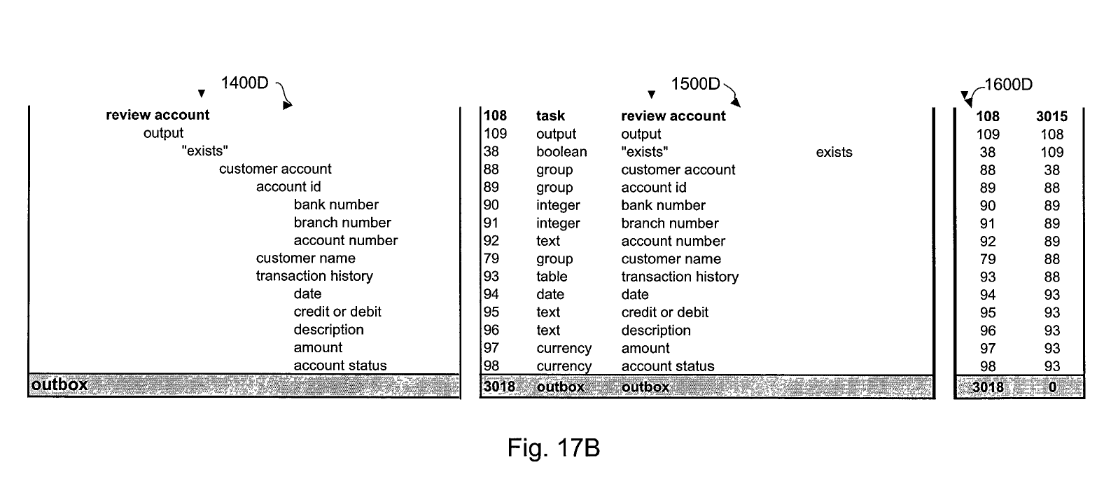

Next, as shown in FIG. 11C, Vera defines a workflow, as discussed above, as represented by container 1160. In this limited illustration of the customer/bank scenario described with reference to FIG. 2, only some of the tasks carried out by the customer and account representative are shown. Specifically, three tasks are shown, Request New Account, Approve New Account, and Review Account, as represented by containers 1162, 1164, and 1166. A container 1170 entitled New Account Request is a shared careabout which represents the new account requested by the customer that must be approved by the AR. Note that not all of the containers required to implement tasks 1162, 1164 and 1166 are shown in FIGS. 11C-11G, but a more comprehensive illustration of the scenario described in FIG. 2 is discussed relative to FIGS. 14-17.

Next, as shown in FIG. 11D, the business analyst Vera promotes the workflow by linking container 1160 to the outbox container 1126. This causes the entire workflow definition to be sent to the knowledge router which persists it in the context of the business scope container 1118.

Next, as shown in FIG. 11E, the participant John subscribes to the knowledge router as a customer, resulting in participant identification container 1152 being persisted in the context of role container 1112. Using pre-defined logic, the knowledge router places the task containers/content which a customer is entitled to execute in the context of participant identification container 1152. In addition, as shown in FIG. 11F, the knowledge router forwards its identity and network address stored in containers 1104 and 1106 to John's end device which persists same in the context of relationships container 1150.

Also, although the persistency of an AR participant is not shown in these examples, FIG. 11F presumes that participant Bill has subscribed to the knowledge router in the role of an AR resulting in a participant identification container 1172 being persisted in the context of AR container 1114. The task containers/content which Bill can execute are placed in context of container 1172.

Referring now to FIG. 11G, as the customer John executes the New Account Request task, the task interpreter on the end device 380B creates a container 1190 which is a copy of the new account request container 1170 (and new containers are created for the progeny of container 1170) and places it in the context of the outbox container 1140 and container 1170. A new container is created because the workflow definition on the end-user device preferably functions as a template for subsequent instances of output containers. The link to the outbox container is 1146 is used by the end-device to trigger the transmission of container 1190 with context ID=1170 to the knowledge router, as symbolically illustrated by arrow 1178. Container 1170 is removed from John's persistency as soon as it is successfully transmitted to the router. Upon receipt, the knowledge router determines the input context of container 1170, namely that it has arrived in the context of container 1170 from John, as represented by container 1152, and using the dynamic context routing rule resolves the output context by traversing the tree of dependencies. In a first leg of the traversal path 1180a, the output context is traced back to the Approve New Account container 1164, from which stem two branches 1180b and 1180c. In this example, resolution is accomplished by traversing the tree until a participant-type container is found. Branch 1180b does not identify a participant but branch 1180c identifies Bill as the participant to whom the new account request container 1190 should be forwarded.

FIG. 11H shows a portion of Bill's persistency. On Bill's end device, the Approve New Account Task is triggered by receipt of the container 1190 in the context of container 1170.

(b) Software Components

FIG. 12A is a block diagram of the major software modules employed by the end device 380. The device includes a messaging service module 1200 which implements the network management layer (Layer 4) of the protocol stack 500 for end devices. The messaging service employs well-known techniques for ensuring reliable communication between the end device and knowledge routers over a network such as the Internet. The messaging service 1200 is associated with two queues, In 1202 and Out 1204. The In queue 1202 holds messages or packets received from the network which must be processed further. For example, if a TCP/IP communications protocol is employed, the packets must be unbundled in to order to extract their payloads, which will be the containers 600 of the preferred embodiment. The Out queue 1204 holds containers which are destined for transmittal to knowledge routers. In this case the messaging service 1202 encapsulates the outbound containers in communication packets for transmission.

A validation module 1206 provides the functionality of the container validation layer (Layer 3) of the protocol stack 500, as described above.

A container handler 1208 provides the functionality of the container handling services layer (Layer 3) of the protocol stack. The handler 1208 includes a verification module 1210 which provides content/container consistency checks, as described above, and a persistency module 1212 which provides storage and retrieval services, as described above. The persistency is sub-divided into at least three spaces: a relationship space 1214 for storing information such as tasks and shared careabouts that are loaded as a result of entering into one or more relationships; a personal space 1216 for information which is either pre-provisioned or is specifically created by a user; and an environment space 1218 for information about the configuration of the device and its environment, such as user settings and network addresses. The dependencies between containers including links which define shared careabouts are stored in space 1219.

An event manager 1220 manages the collection of various events and initiates the execution of content depending on the type of event received. Events include: receipt of a valid container, as notified by the verification module 1210; a change to a container stored in persistency; time or date based events; and user initiated events such as user-initiated tasks. The event manager 1220 includes an event table 1222 which is built from the containers of content type “trigger” that are stored in the persistency 1212, whose content specifies the particular events that initiate workflow tasks. The table may also be built from other content types which initiate other kinds of processes. When an event such as receipt of a valid container is detected, the event manager 1220 scans the event table 1222 to determine what workflow task(s) should be initiated, or alternatively what other type of process should be initiated since the architecture of the preferred embodiment can be employed to execute other kinds of predefined processes based on content type. Once the corresponding container(s) are identified, the event manager 1220 passes the identity of the container to a content executor 1224 which manages execution of content based on its type, as described above.

The content executor 1224 calls an appropriate interpreter 1226 to execute the content. Some of these interpreters, in turn, call other interpreters as necessary in order to execute the content. For example, referring back to the isolated example of the task 1030 presented FIGS. 10B-10D, a task interpreter 1226a proceeds to evaluate the pre-condition 1034, quantity>0, and will call a math interpreter 1226b to evaluate the boolean expression. Then the task interpreter 1226a proceeds to parse and execute the output. In doing so, it will call a SOAP interpreter 1226c to execute container 1042 and provide the content for the share price container 1044, and then call the math interpreter 1222b to evaluate the contents of the cost container. The content executor 1224 manages this process, including interfacing with the persistency 1212 as required. As a result of this, the contents of some containers in the persistency may change, which can trigger other tasks or other kinds of processes. When the contents of a container in the persistency 1212 that is a shared careabout changes, the content executor 1224 also places a copy of the changed container in the Out queue 1204 for transmission by the message service 1200 to the appropriate knowledge router.

The task interpreters 1226 and the event manager 1220 interface with one or more interaction agents 1228 (only one being shown) which provide the services defined in the interaction layer of the protocol stack, including displaying the contents of containers to the end-user and/or requesting input from the user. In the preferred embodiment the interaction agent 1228 that interfaces with the task interpreter derives its input/output information from task definitions 1020 (see FIG. 10).

In one embodiment, where a container (that is amenable to I/O) is placed in the context of both the pre-condition 1024 and the output 1026, the content of container is displayed only. If the container is placed in context of the pre-condition 1024 only, the content of container is displayed only. If the container is placed in context of the output 1026 only, the content of the container, if any, is displayed and may be edited by the user. In this case the interaction agent 1228 will seek user input. In the event the container is placed in the context of the post-condition the container may be edited, irrespective of any other contexts.

In an alternative embodiment tasks may be defined with dependent containers of “input” and “display”. The interaction agent 1228 requests user input for containers that are placed in the context of the input container. Containers that are placed in the context of the display container only are only displayed. Containers can be both displayed and edited when placed in the context of both the input and display containers.

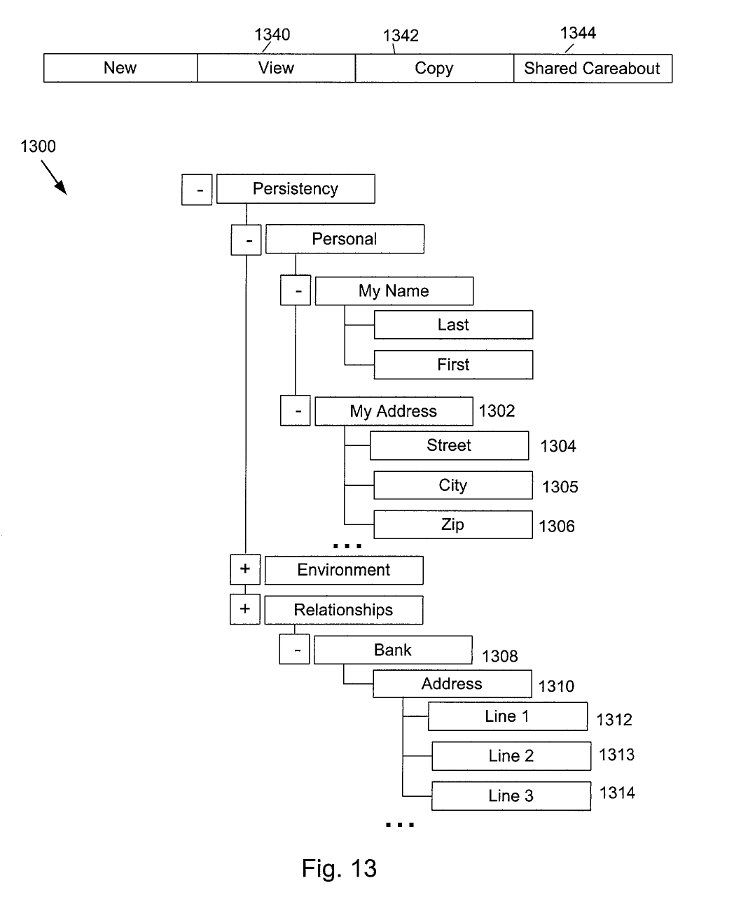

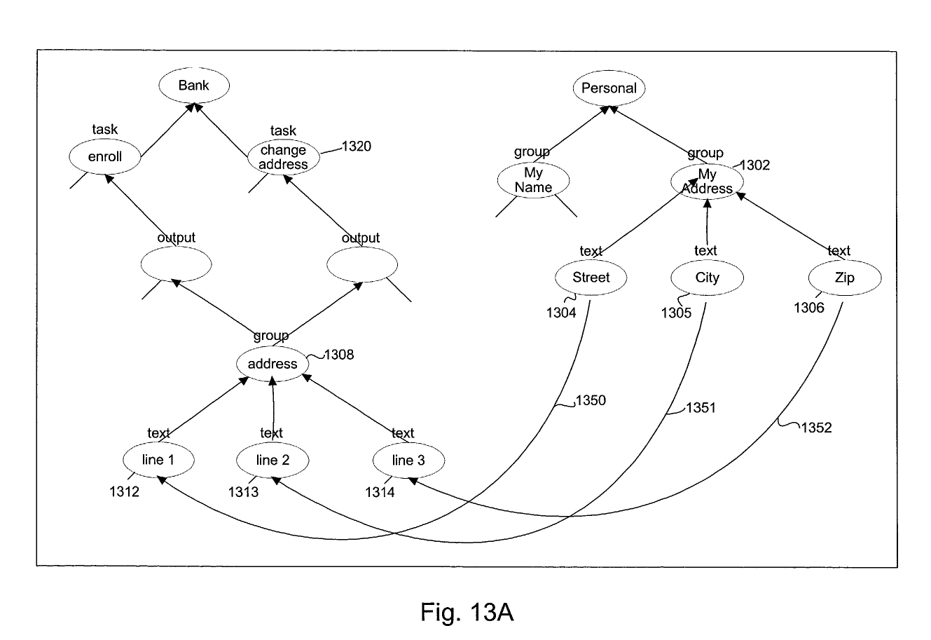

The interaction agent 1228 also provides a variety of persistency functions that enable the user to view the current state of the persistency 1212, copy parts of it and explicitly define links between containers. In the preferred embodiments, the interaction agent 1228 provides a hierarchical display tool 1300 exemplified in FIG. 13 for viewing the persistency 1212, which operates similar to the manner in which Microsoft Windows Explorer™ enables users to view the contents of a disk drive. Shared careabouts can be displayed using visual attributes such as colour or pre-determined icons situated next to the container name, or by relationship lines visually linking containers. This tool also readily enables one to view the various properties of a container, much like it is possible to view the attributes or properties of a file or directory stored on a hard drive. The tool also allows filters to be activated, which hide some of the complexity of persistence. For example, in the view of FIG. 13 tasks are not shown only the outputs thereof, which is why container 1310 is shown adjacent to container 1308. Views are controlled via a view function 1340.

In the preferred embodiment, one of the functions provided by the interaction agent 1228 is the ability for the user to explicitly provision information requested in the context of one relationship using pre-existing information from another relationship. For instance, when user input is required, the interaction agent 1228 presents an input field(s) to the user in order to provide the content for the underlying container (the “requesting container”). Through the use of a pre-defined mechanism such as a function key or icon (not shown), rather than typing the data in, the user may initiate the tool 1300 to display the persistency 1212 and link an existing container to the requesting container, whereby the contents of the existing container are linked to the requesting container. The link can be permanent, resulting in a shared careabout, or fleeting, resulting in a transfer of contents.

For example, in FIG. 13, container My Address 1302 (within the context of personal information) is the existing container and container Address 1304 (within the context of a banking relationship) is the requesting container.

Actuating a copy icon 1342, or by “dragging and dropping” container 1302 over container 1310, results in the copying of the contents of street, city and zip containers 1304, 1305 and 1306 to copies of the Line-1, Line-2 and Line-3 containers 1312, 1313 and 1314. (This is because the task interpreter uses containers 1312, 1313 and 1314 as templates for outputs, as described above.)

However, if shared carebout icon 1344 is actuated, the interaction agent 1228 preferably establishes an association between leaf containers 1304, 1305 and leaf containers 1312, 1313 and 1314, placing the former in context of the latter. This scenario is depicted in FIG. 13A, where container 1308 exists in the context of two tasks, “enrol” and “change address”. As before, the interaction agent 1228 copies the contents of containers 1304, 1305 and 1306 to copies of containers 1312, 1313 and 1314, here containers 1312C, 1313C and 1314C. Container 1398 (having context ID=1308) is transmitted to the knowledge router for routing. However, having thus established a shared careabout, any change that the user makes to containers 1304, 1305 and 1306 in the personal space can be propagated to shared relationships. This can be accomplished in a number of ways.

In the preferred embodiment, one of the pre-provisioned events that is monitored by each end device is a change in the state of the personal space. This sets off a special function in the content executor which scans persistency to determine what relationships and tasks are affected by the change, and present them to the participant so that he or she can execute the affected tasks, as desired. In this example, changes to containers 1304, 1305 and 1306 affect the “enrol” and “change address” tasks of the bank.

Alternatively, the bank could define a triggering event for the “change address” task to be a change in the state of address container 1308. Since containers 1304, 1305 and 1306 have been placed in the context of container 1308, changes to these could automatically trigger the “change address” task.

In the further alternative, links 1350, 1351, and 1352 between containers 1304, 1305 and 1306 and containers 1312, 1313 and 1314 can be tagged to indicate to the task interpreter that all future references to the latter should be redirected to the former. These equivalency or re-direction links can be stored in an equivalency table 1250 of the persistency 1212 (FIG. 12A).

Using such functions, the user will also be able to consolidate information from multiple relationships into a view of his or her or own choosing, using terms that are familiar to the user. This enables each participant, working in conjunction with one or more knowledge routers, to thus maintain a unique vocabulary for that individual whilst the system translates the individual's vocabulary to the vocabulary used by other participants. Moreover, the user can set the usage rights for each container in his or her personal space, thereby defining the privacy and trust policies of the user's choice.

A presentation module 1230 (FIG. 12A) provides the services of the presentation layer.

FIG. 12B shows the major software modules employed by knowledge routers. The device includes the messaging service module 1200 and a routing engine 1260 which implements the network management layer portion of the protocol stack for Knowledge routers. The validation module 1206 and a container handler 1208′ which functions similar to the end device container handler 1208 are also included, as discussed above.

On ingress, the knowledge router receives a message from the end device which is unpackaged by the messages 1200. Containers are delivered to the validation module 1206 which validates the structure thereof. Containers are then sent to the container handler 1208′ which verifies the content of each container against its content type, and stores the container in a work queue (not shown) of the persistency 1212.

On egress, the routing engine 1260 retrieves container from the work queue and identifies the destination of the container, as discussed above. The container is delivered to the out queue 1204 of the message service 1200 for final transport to the destination end device.

(c) Detailed Example

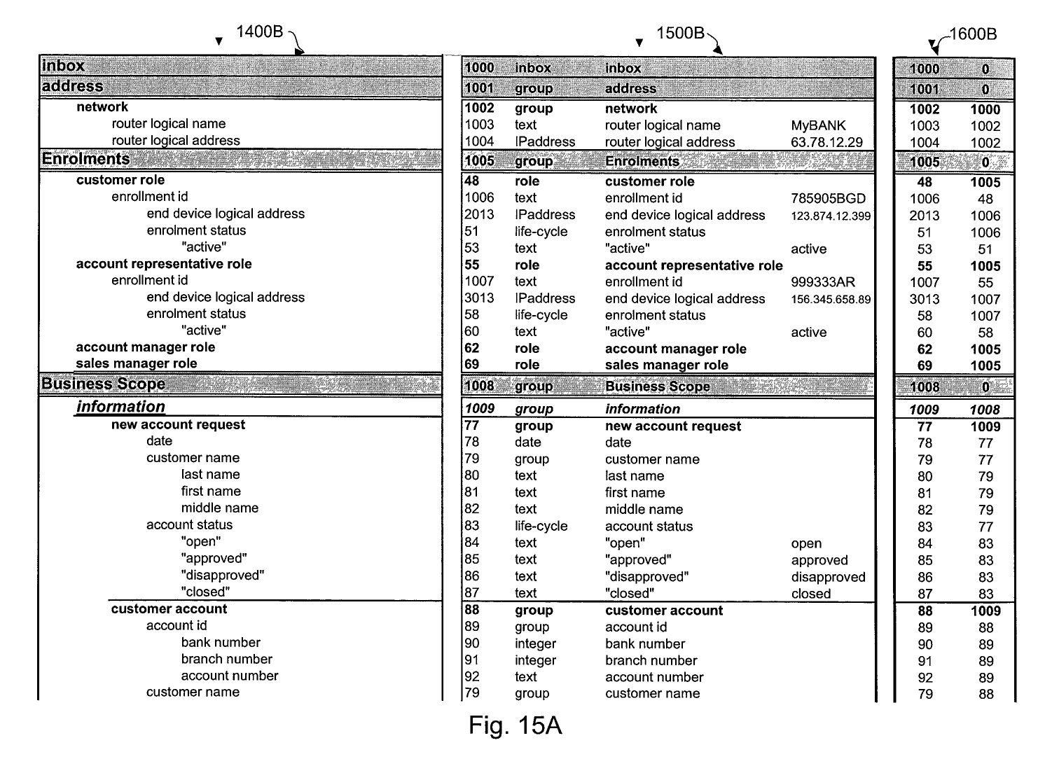

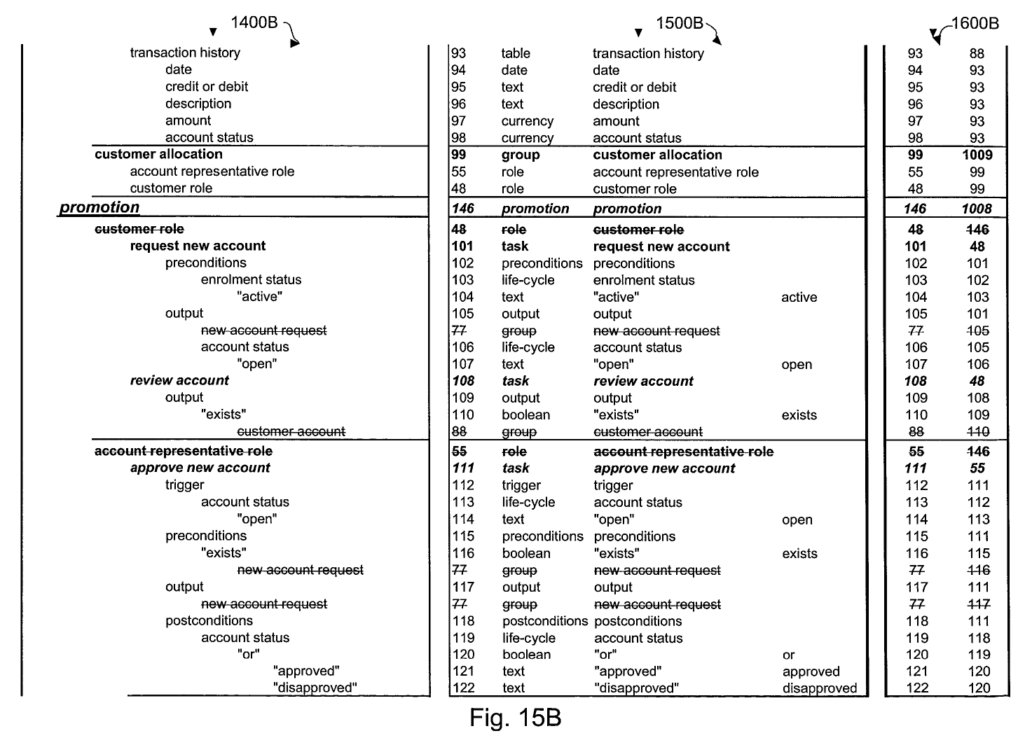

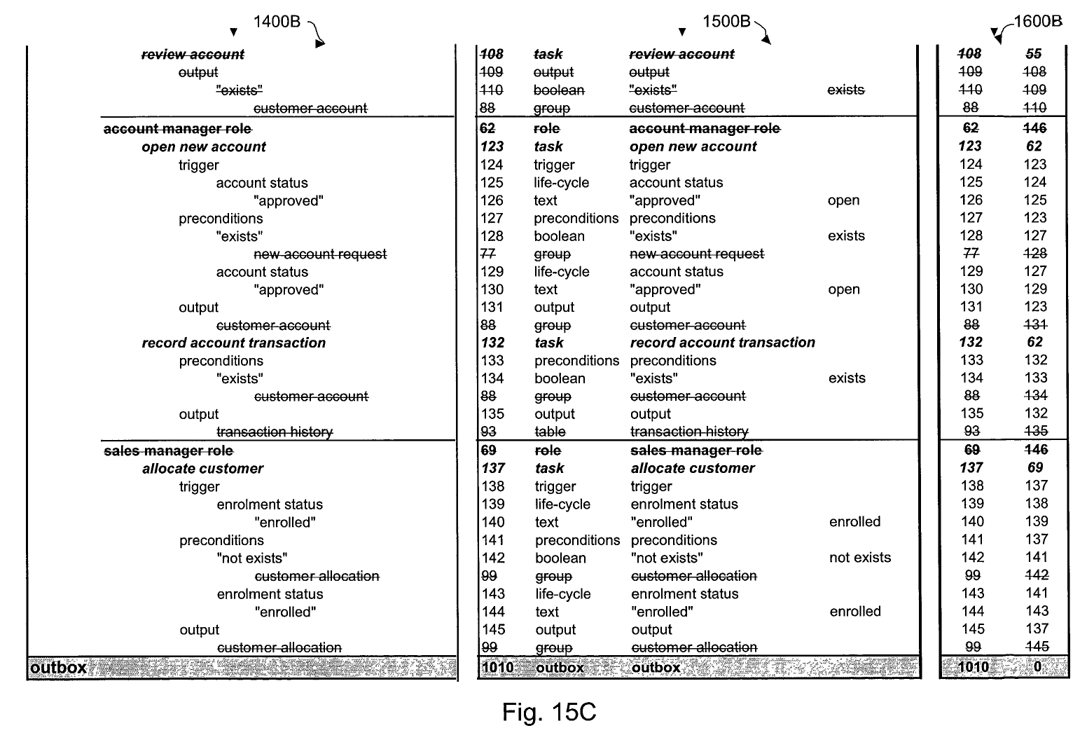

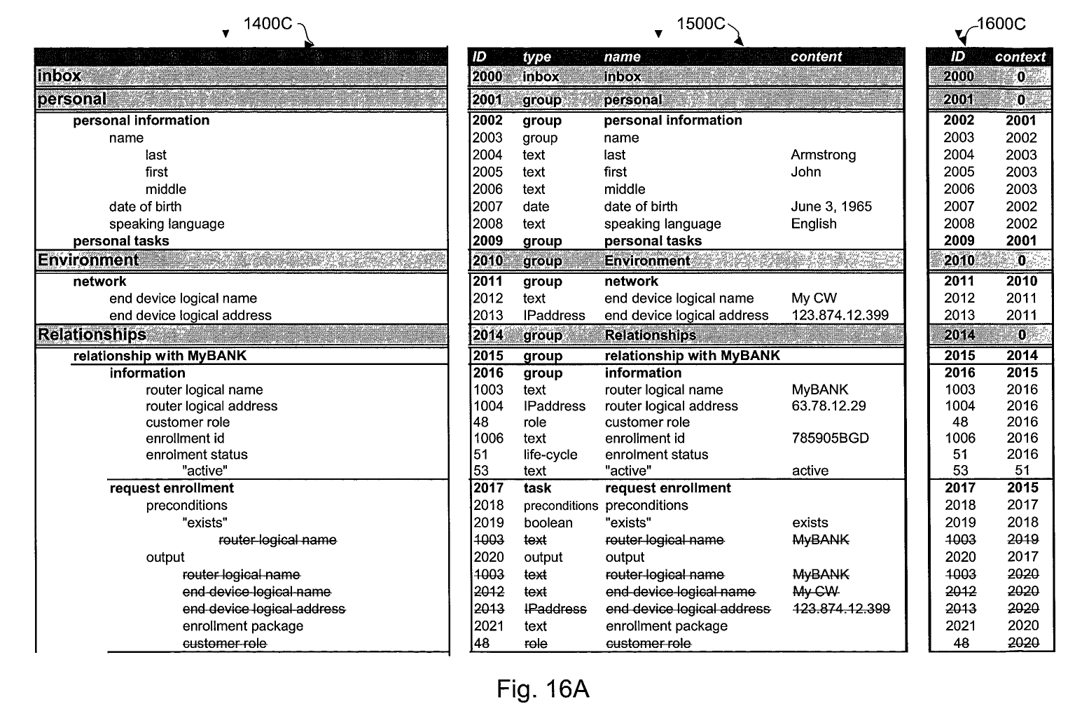

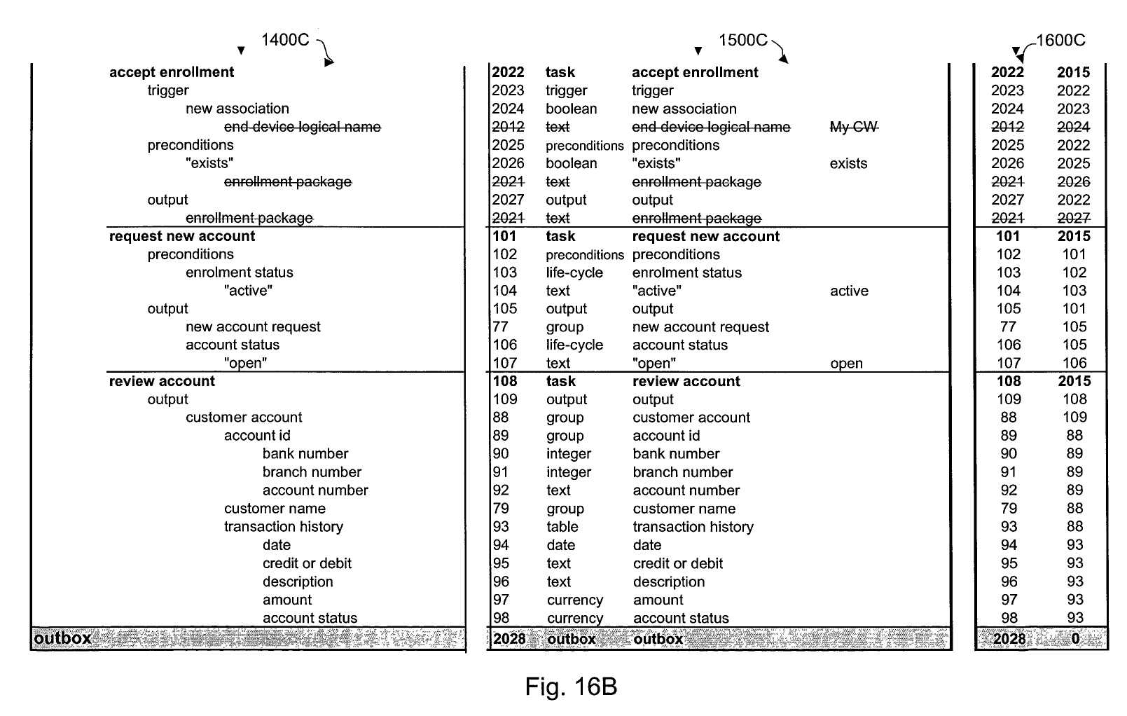

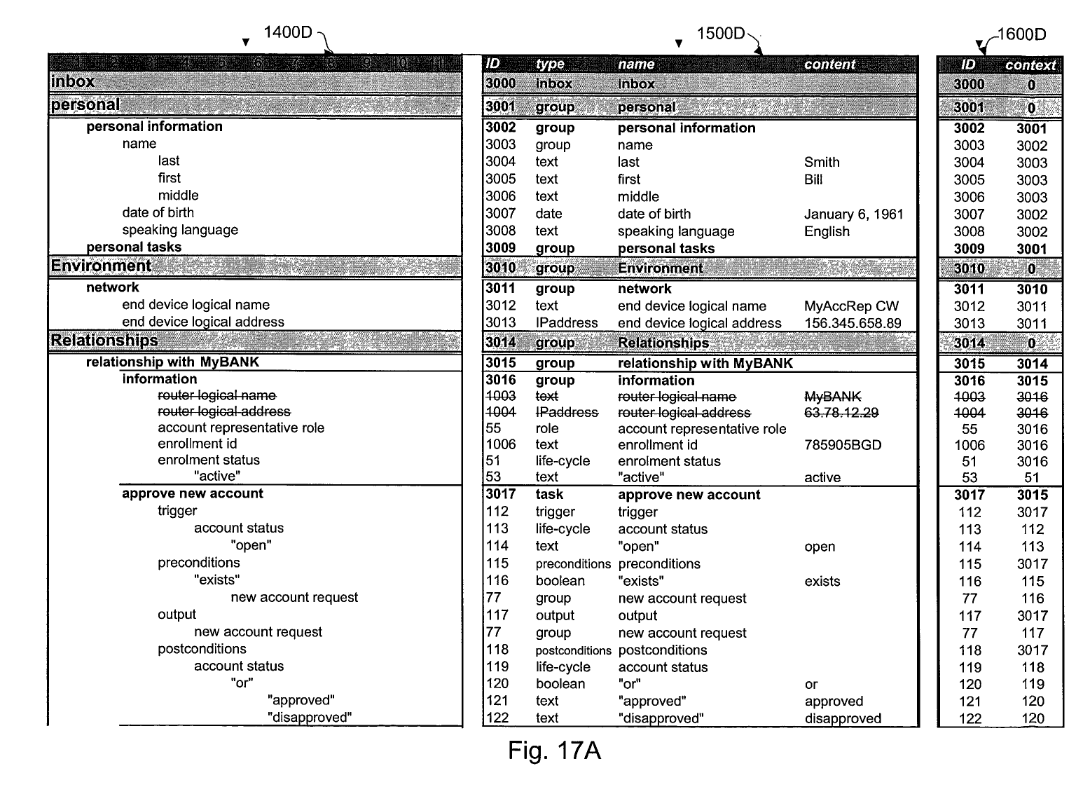

FIGS. 14, 15, 16 and 17 present a detailed example of the Account Management scenario generally illustrated in FIG. 3. FIG. 14 shows the persistency on the end device of the business analyst, who defined the workflow. FIG. 15 shows the persistency on the knowledge router, which has the responsibility for routing containers in the context of this workflow. FIG. 15 shows the persistency of a participant in the role of a customer and FIG. 16 shows the persistency of a participant in the role of an account representative. Note that in these diagrams tables 1400A, 1400B, 1400C and 1400D are anthropocentric views of persistency that are not acted upon by the end devices or knowledge router. Tables 1500A, 1500B, 1500C and 1500D list containers, including their IDs, types, names and content. Each of these tables holds only one instance of each container. Containers that are shown in strikeout font do not form part of the table per se, but are shown to facilitate understanding. For instance, FIG. 14 (specifically, FIG. 14C) shows a first appearance of container ID no. 79 (ref. no. 1510) in regular font and a second appearance of container ID no. 79 (ref. no. 1512) in strikeout font. It should be understood that the second appearance of this container (ref. no. 1512) indicates that it is already present in the table 1500A (i.e., not another instance of the same container) and that this container is a shared careabout. Tables 1600A, 1600B, 1600C and 1600D are network tables which store dependencies. It will be seen from entries 1610 and 1620 in table 1600A (FIG. 14C) that the container ID no. 74 is positioned in the context of container ID no. 72 and container ID no. 83.

Referring to FIG. 14, the Artifacts section 1410 groups together organizational knowledge that the business analyst uses in defining workflows. The workflow definitions begins at reference no. 1412, and comprises four roles:

1. Customer, whose tasks are “Request a New Account” and “Review Status” of an existing account;

2. Account Representative, whose tasks are to “Approve a New Account” request and to “Review Customer's Account Status”;

3. Account Manager, whose tasks are to “Create New Account” and “Record Account Transaction”; and

4. Sales Manager, whose tasks are to “Assign” newly enrolled customers to a specific account representative.

The workflow is designed to carry out the following objectives (and presumes that the customer has already enrolled in the relationship):

1. The sales manager allocates an enrolled customer to an account representative.

2. The customer sends a “new account request” request to the account representative.

3. The account representative changes the status of the “new account request” to “approved”, or “disapproved”.

4. If the “new account request” status is “approved”, the account manager opens a new “customer account”.

5. The account manager records each transaction in a transaction history.

6. At any time following opening of a “customer account”, its status can be viewed by the customer or its account representative.

The following is a detailed description of the tasks available by role.

Role: Customer

Task: Request New Account

This task is initiated by a Customer. On the pre-condition that Enrolment Status is active, a New Account Request container (ID 77) is created and the Account Status (container ID 83) (which an element of the New Account Request) is changed to “open”.

Task: Review Account Status

This task may be initiated by a customer. The pre-condition is the existence of a Customer Account container (ID 88). If it exists, it will be presented to the customer.

Role: Account Representative

Task: Approve New Account

This task is triggered by a change in the Account Status (container ID 83) to “open”. The pre-condition is the existence of a New Account Request container (ID 77). If it exists, it will be presented to the account representative. Depending on his or her action, Account Status is changed to “approved” or “disapproved”.

Task: Review Account Status

This task may be initiated by the account representative, as discussed above.

Role: Account Manager

Task:: Open New Account

This task is triggered by a change in the status of the New Account Request to “approved”. The pre-condition is the is the same as the trigger. If the status of the New Account Request is “approved”, a Customer Account container (ID 88) is created.

Task:: Record Account Transaction

The precondition is the existence of a Customer Account container. If it exists, a Transaction History container is created.

Role: Sales Manager

Task: Allocate Customer

This task is triggered by a change in Customer Status to “enrolled”. The precondition is the existence of a Customer Allocation container with Customer Status being “enrolled”. If both exist, an instance of the Customer Allocation container containing a single account representative and a customer is created.

4. Glossary

In order to ease the understanding of the terms employed in the specification, the following glossary is presented:

Careabout is any information which a participant requires (“cares about”) for the purpose of playing a role in a particular workflow, or for personal purposes.

Container is a data structure which includes content and an abstraction of its properties.

Container ID is an identifier which preferably uniquely distinguishes a container from all others in a knowledge network.

Content can be any information in electronic form. In the preferred embodiment content is encapsulated in a container. The encapsulated content is preferably atomic in nature given the scope of the business application in which the content exists.

Content Type is an identifier which determines the type of content encapsulated in a container. The type signifies how the content should be executed by one or more methods provided by interpreters.

Context Indicator is an indicator which associates a container with a parent (originator) container. In the preferred embodiment the context identifier assumes the value of the container ID of another container.

Context Information can be direct or indirect, and unless textual connotation dictates otherwise, means direct and indirect. Direct context information specifies an immediate dependency between an information element, such as a container, and its parent information element. Indirect context information specifies an indirect dependency between an information elements and one if its ancestors, e.g., grandparent information element.

Context Routing refers to routing an information element such as a container based on its context in a topology base.

End Device is a device such as a computer which includes a data processor. End devices are used by participants to execute pre-determined tasks delivered to the participant as a result of subscription. An end device can support one, or more, participants.

Interaction Agent enables basic input/output capabilities. In the preferred embodiment it also provides a window to persistence, i.e. a view of the organization and content of the persistence. Together with a presentation means, the interaction agent allows a participant to view the persistence using a “look and feel” format (skin) of the user's choice. In the preferred embodiment the interaction agent enables a participant to establish shared careabouts with respect to his or her personal information.

Interpreter is a collection of methods or procedures which parse and/or execute content based on its type.

Input Container is a container received by a knowledge broker which must be routed to one or more recipients based on a topology accessed by the knowledge router. In the preferred embodiment input containers originate from a participant as a result of the execution of a workflow.

Input Context is context information associated with an information element, such as a container, which indicates an origination point (branch or path) in a topology. An input container requires some context information in order to identify from where the input container originated, so that an output context(s) can be identified. The output context enables the recipient of the container to be resolved.

Knowledge Router is a device which maintains a topology of information elements, some of which represent end entities or network end points. The knowledge router receives an input container and context information for identifying its input context in the topology; determines an output context(s); resolves the end entity(ies) associated with the output context(s); and forwards the input container thereto. In the preferred embodiment the topology is a model of a workflow, including participants, the roles they instantiate, and the tasks allotted to each participant. The knowledge router forwards shared careabouts to other participants.

Output Context is, relative to an input container, context that is not input context. The output context enables the recipient(s) of the input container to be resolved.

Participant—an individual or organizational entity, including a machine such as a legacy computer system.

Persistence refers to a non-volatile repository of information elements, such as the containers of the preferred embodiment, and their associations (i.e., context links). In the preferred embodiment, persistence is divided into three sections: a personal space of participant, relationship space and environment space.

Platform is the infrastructure that delivers and handles content.

Presentation is a means for presenting information to a participant using a look and feel format selected or required by the participant.

Relationship refers to particular connection between a participant and an enterprise.

Role describes a participant in a specific workflow. A single participant can have multiple roles in the context of different relationships. In the preferred embodiment, a role is instantiated by a container.

Shared Careabout is an information element such a container that two or more participants, or the same participant in two or more roles, requires for use in one or more workflows.

Subscription refers to the instantiation of a role.

Steering Information is information which allows a router to select a particular branch or node of a network topology.

Task, generally speaking, is one or more actions that may be carried out by a participant in a workflow. In the preferred embodiment, a task is defined by a container of type task and a plurality of other containers dependent thereon which collectively are executed by a task interpreter.

Workflow is a collection of roles and the tasks allotted thereto which in the preferred embodiment are represented by containers of different content types. Participants instantiate one or more roles in a workflow.

It will thus be seen that the preferred embodiment provides a secure, distributed, owner-administered, knowledge management system while providing a robust—nearly organic—network of peer node processing environments capable of enabling collaborative processing of owner-held data in trusted relationships. Those skilled in the art will understand that numerous modifications and variations may be made to the embodiments described herein without departing from the spirit of the invention.

1. A routing method for use by a knowledge router communicating with a plurality of logical end entities, the method comprising:
providing a topology defining logical dependencies between a plurality of information elements, wherein at least two information elements respectively provide context for a third information element, and wherein some of the information elements in said topology represent said end entities;
receiving an input information element from one of said end entities and context information for identifying a direct or indirect input context of the input information element in said topology;
determining at least one output context for the input information element; and
resolving one or more end entities logically associated with the at least one output context and forwarding the input information element thereto.

2. A method according to claim 1, wherein the determination of said output context is based on matching the identity of said input container in said topology.

3. A method according to claim 1, wherein said context information includes the identity of another information element in said topology other than said input information element.

4. A method according to claim 3, wherein said output context is determined by finding said input information element in said topology and considering the relationship of said input information element to said other information element.

5. A method according to claim 1, wherein said context information includes the identity of the information element representing the sending end entity.

6. A method according to claim 5, wherein said output context is determined by finding said input information element in said topology and considering the relationship of said input information element to said sending-entity information element.

7. A method according to claim 1, wherein said context information includes the identity of another information element in said topology and the identity of the information element representing the sending-end entity.

8. A method according to claim 7, wherein said output context is determined by finding said input information element in said topology, and considering the relationship of said input information element to said other information element and said sending-entity information element.

9. A method according to claim 7, wherein said output context is determined by finding said other information element in said topology and considering the relationship of said other information element to said sending-entity information element.

10. A method according to claim 1, wherein said topology includes steering information for resolving the end entities logically associated with the output context.

11. A method according to claim 10, wherein said steering information comprises an information element which links an information element representing a sending entity with an information element representing a recipient entity.

12. A method according to any of claims 1-11, wherein each said information element is an information container structured to include:
a content field;
a unique identifier field; and
at least one context field which assumes the value of the identifier of another container.

13. A knowledge router, comprising:
a topology defining logical dependencies between a plurality of information elements, wherein at least two information elements respectively provide context for a third information element, and wherein some of the information elements in said topology represent end entities;
a data processor programmed to receive an input information element from one of said end entities and context information for identifying a direct or indirect input context of the input information element in said topology; determine at least one output context for the input information element; resolve one or more end entities logically associated with the at least one output context; and forward the input information element thereto.

14. A router according to claim 13, wherein the determination of said output context is based on matching the identity of said input container in said topology.

15. A router according to claim 13, wherein said context information includes the identity of another information element in said topology other than said input information element.

16. A router according to claim 15, wherein said output context is determined by finding said input information element in said topology and considering the relationship of said input information element to said other information element.

17. A router according to claim 13, wherein said context information includes the identity of the information element representing the sending end entity.

18. A router according to claim 17, wherein said output context is determined by finding said input information element in said topology and considering the relationship of said input information element to said sending-entity information element.

19. A router according to claim 13, wherein said context information includes the identity of another information element in said topology and the identity of the information element representing the sending-end entity.

20. A router according to claim 19, wherein said output context is determined by finding said input information element in said topology, and considering the relationship of said input information element to said other information element and said sending-entity information element.

21. A router according to claim 19, wherein said output context is determined by finding said other information element in said topology and considering the relationship of said other information element to said sending-entity information element.

22. A router according to claim 13, wherein said topology includes steering information for resolving the end entities logically associated with the output context.

23. A router according to claim 22, wherein said steering information comprises an information element which links an information element representing a sending entity with an information element representing a recipient entity.

24. A router according to any of claims 13-23, wherein each said information element is an information container structured to include:
a content field;
a unique identifier field; and
at least one context field which assumes the value of the identifier of another container.
